(19) United States
(12) Patent Application Publication
(10) Pub. No.: US 2015/0382283 A1
(43) Pub. Date: Dec. 31, 2015

(54) Access Points, Radio Communication Devices, Methods for Controlling an Access Point, and Method for Controlling a Radio Communication Device

(71) Applicant: AGENCY FOR SCIENCE, TECHNOLOGY AND RESEARCH, Singapore (SG)

(72) Inventors: Haiguang WANG, Singapore (SG); Yuan ZHOU, Singapore (SG); Shoukang ZHENG, Singapore (SG); Zhongding LEI, Singapore (SG)

(73) Assignee: AGENCY FOR SCIENCE, TECHNOLOGY AND RESEARCH, Singapore (SG)

(21) Appl. No.: 14/441,426

(22) PCT Filed: Nov. 11, 2013
(86) PCT No.: PCT/SG2013/000481

§ 371 Date: May 7, 2015

(30) Foreign Application Priority Data
Nov. 9, 2012 (SG) 201208311-9
Dec. 12, 2012 (SG) 201209132-8
Mar. 13, 2013 (SG) 201301863-5
May 10, 2013 (SG) 201313655-3
Sep. 9, 2013 (SG) 201306776-4
Sep. 17, 2013 (SG) 201307029-7

(51) Int. Cl. H04W 48/12; H04W 48/16; H04W 52/02

(52) U.S. Cl. CPC H04W 48/12; H04W 52/02; H04W 48/16; H04W 88/08

(57) ABSTRACT

According to various embodiments, an access point may be provided. The access point may include: a transmitter configured to transmit restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

### CROSS-REFERENCE TO RELATED APPLICATIONS

The present application claims the benefit of the Singapore patent application No. 201301863-5, filed on 13 Mar. 2013, the Singapore patent application No. 201208311-9, filed on 9 Nov. 2012, the Singapore patent application No. 201209132-8, filed on 12 Dec. 2012, the Singapore patent application No. 201303655-3, filed on 10 May 2013, the Singapore patent application No. 201306776-4, filed on 9 Sep. 2013, and the Singapore patent application No. 201307029-7, filed on 17 Sep. 2013, the entire contents of which are incorporated herein by reference for all purposes.

### TECHNICAL FIELD

Embodiments relate generally to access points, radio communication devices, methods for controlling an access point, and method for controlling a radio communication device.

### BACKGROUND

An access point may indicate information about a restricted access window to a radio communication device. An efficient signaling may be desired.

### SUMMARY

According to various embodiments, an access point may be provided. The access point may include: a transmitter configured to transmit restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, a radio communication device may be provided. The radio communication device may include: a receiver configured to receive restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, a method for controlling an access point may be provided. The method may include: transmitting restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, a method for controlling a radio communication device may be provided. The method may include: receiving restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a mobile radio communication system;

FIG. 1B shows an access point according to various embodiments;

FIG. 1C shows a radio communication device according to various embodiments;

FIG. 1D shows a flow diagram illustrating a method for controlling an access point according to various embodiments;

FIG. 1E shows a flow diagram illustrating a method for controlling a radio communication device according to various embodiments;

FIG. 2 shows an illustration of an example of virtual TIM segment & (and) virtual RAW slot assignment;

FIG. 3 shows an illustration of an example of virtual RAW slot where non-TIM STA sends PS-Poll again and AP responds to the non-TIM STA after the wakeup timer expires;

FIG. 4 shows an illustration of an example of virtual RAW slot assignment where AP immediately sends data to the non-TIM STA after the wakeup timer expires;

FIG. 5 shows an illustration of the separate RAWs for unicast and multicast traffic delivery;

FIG. 6 shows an illustration of the separate RAWs for unicast and multicast traffic delivery;

FIG. 7 shows an illustration of the combined RAW for unicast and multicast traffic delivery;

FIG. 8 illustrates the EDCA backoff procedure for PRAW where two non-TIM STAs;

FIG. 9 shows an illustration of a RAW-PS IE format according to various embodiments;

FIG. 10 shows an illustration of a RAW-PS IE format according to various embodiments;

FIG. 11 shows an illustration of an example of default operating mode according to various embodiments;

FIG. 12 show an illustration, where it is assumed a single mode indication bit is used in a field that contains common control signaling in RAW-PS IE;

FIG. 13 shows an illustration of an example of a single-bit format indication according to various embodiments;

FIG. 14 shows an illustration of a RAW-PS IE with RA mode indication according to various embodiments;

FIG. 15 shows an illustration of a RAW-PS IE with RA mode indication according to various embodiments;

FIG. 16A, FIG. 16B, and FIG. 16C show illustrations of RAW operating modes;

FIG. 17 shows an illustration of a use of multiple RPS-IEs to support multi-RAW operation;

FIG. 18 shows an illustration of scheduling of non-TIM STA to contention-free RAW/reduced contention RAW via Beacon;

FIG. 19 shows an illustration of scheduling of non-TIM STA based on RA frame;

FIG. 20 shows an illustration of scheduling of non-TIM STA via Beacon for two-RAW operation;

FIG. 21 shows an illustration of scheduling of non-TIM STA via RA frame directly in two-RAW operation;

FIG. 22 shows an illustration of RAW protection based on response timer. STA uses RTS to initiate uplink transmission;

FIG. 23 shows an illustration of RAW protection based on response timer. STA transmits uplink data directly without RTS;

FIG. 24 shows an illustration of the AP using a broadcast CTS to defer STA's channel access;

FIG. 25 shows an illustration of indicating RAW with a bit in frame control field;

FIG. 26 shows an illustration of Group Address Buffered Data Bit Indication in Bitmap Control Field of TIM IE;

FIG. 27 shows an illustration of the operation of RAW;

FIG. 28 shows an illustration of an example RA frame format;

FIG. 29 shows an illustration of an example of a potential collision caused by OBSS STA in RAW operation;

FIG. 30 shows an illustration of an example method for downlink protection indication within a RAW in RPS IE;

FIG. 31 shows an illustration of an example method for downlink protection indication within a RAW in RA;

FIG. 32 shows an illustration of an example where AP specifies downlink protection indication in RA Slot assignment for STA1;

FIG. 33 shows an illustration of an implicit RAW slot assignment with unassigned AIDs;

FIG. 34 shows an illustration of an example of RAW Slot protection indication;

FIG. 35 shows an illustration of an example of RAW Slot protection indication;

FIG. 36 shows an illustration of a format of RPS information element according to various embodiments;

FIG. 37 shows an illustration of the subfield defined for Regular RAW;

FIG. 38 shows an illustration of the slot definition;

FIG. 39 shows an illustration of a format of RAW N assignment field for AP PM RAW;

FIG. 40 shows an illustration of the RAW N format for PRAW;

FIG. 41 shows an illustration of a unified structure for RAW assignment field according to various embodiments;

FIG. 42 shows an illustration of a RAW assignment field format according to various embodiments;

FIG. 43 shows an illustration of a definition of RAW control subfield according to various embodiments;

FIG. 44 shows an illustration of periodic operation parameters according to various embodiments;

FIG. 45 shows an illustration of a decoding order of the RAW information body according to various embodiments;

FIG. 46 shows a flow diagram illustrating an encoding method for a RAW field according to various embodiments; and

FIG. 47 shows a flow diagram illustrating a decoding method for a RAW field according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the access point as described in this description may include a memory which is for example used in the processing carried out in the access point. In this context, the radio communication device as described in this description may include a memory which is for example used in the processing carried out in the radio communication device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

An access point may indicate information about a restricted access window to a radio communication device. An efficient signaling may be desired.

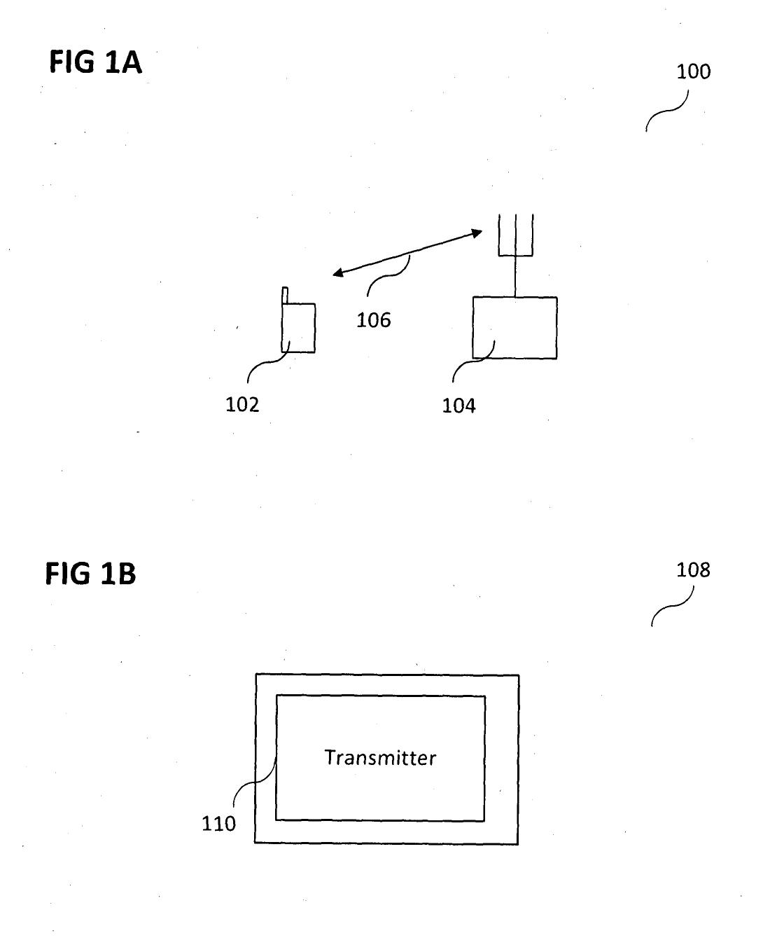

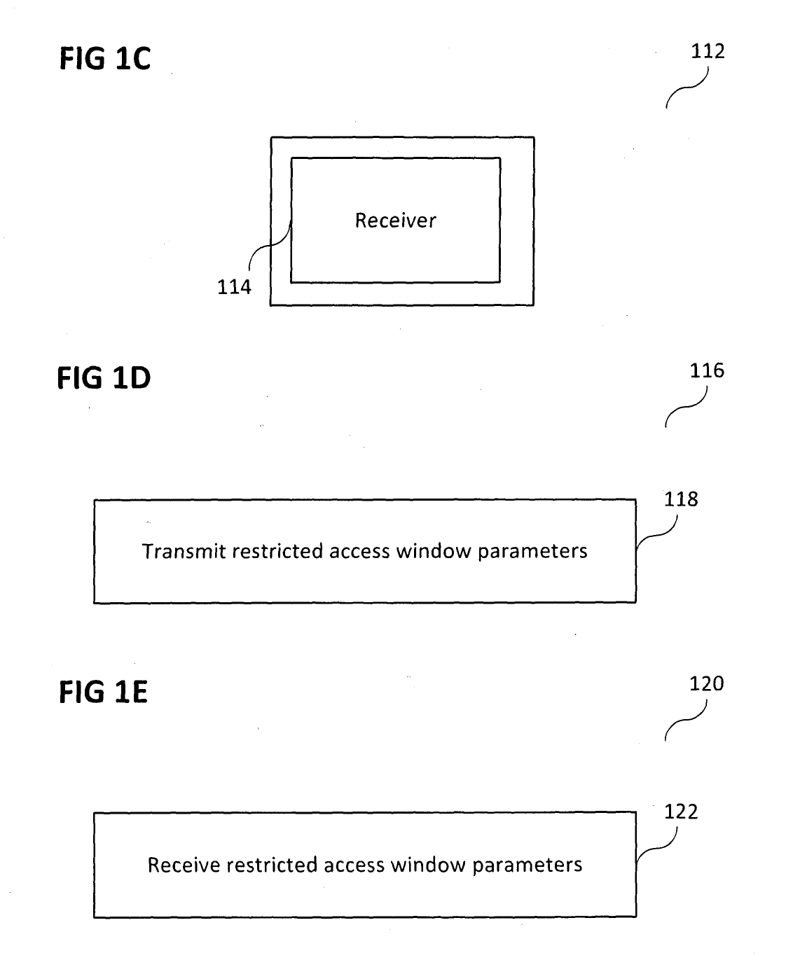

FIG. 1A shows a mobile radio communication system 100. A radio communication terminal 102 (for example a mobile station, for example referred to by STA) may communicate with an access point 104, like indicated by arrow 106. The access point 104 (AP) may indicate to the mobile station 102 when it has data for the station 102.

FIG. 1B shows an access point 108 according to various embodiments. The access point 108 may include a transmitter 110 configured to transmit (for example to a radio communication device, for example as shown in FIG. 1C, for example a STA) restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

In other words, the access point 108 may transmit restricted access window parameter sets of various kinds.

According to various embodiments, the type of restricted access window parameters may include or may be restricted access window parameters indicating parameter for a plurality of restricted access windows.

According to various embodiments, the restricted access window parameters may include at least one common parameter for the plurality of restricted access windows.

According to various embodiments, the type parameter may include or may be a parameter of a subsequent restricted access window.

According to various embodiments, the restricted access window parameters may include a same group parameter indicating whether parameters for a restricted access window are valid for a group of radio communication devices identical to a group of radio communication devices, for which the previous restricted access window parameters are provided.

According to various embodiments, the type parameter may include or may be a parameter indicating whether the restricted access window parameters define a pre-determined default operation mode.

According to various embodiments, the restricted access window parameters may include or may be a parameter indicating whether a random slot assignment is provided.

According to various embodiments, the restricted access window parameters may include or may be a periodic operation validity parameter indicating the number of periods the periodic operation of the restricted access window repeats.

According to various embodiments, the type parameter may indicate whether the restricted access window parameters are parameters for a regular restricted access window, for a power saving mode restricted access window, for a periodic restricted access window, or for a sounding restricted access window.

According to various embodiments, the type parameter may indicate whether the restricted access window parameters are parameters in which one or more of the following parameters are provided: start time indication; slot definition; same group indication; channel indication; periodic restricted access window periodicity; or periodic restricted access window start offset.

FIG. 1C shows a radio communication device 112 according to various embodiments. The radio communication device 112 may include a receiver 114 configured to receive restricted access window parameters. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, the type of restricted access window parameters may include or may be restricted access window parameters indicating parameter for a plurality of restricted access windows.

According to various embodiments, the restricted access window parameters may include at least one common parameter for the plurality of restricted access windows.

According to various embodiments, the type parameter may include or may be a parameter of a subsequent restricted access window.

According to various embodiments, the restricted access window parameters may include a same group parameter indicating whether parameters for a restricted access window are valid for a group of radio communication devices identical to a group of radio communication devices, for which the previous restricted access window parameters are provided.

According to various embodiments, the type parameter may include or may be a parameter indicating whether the restricted access window parameters define a pre-determined default operation mode.

According to various embodiments, the restricted access window parameters may include or may be a parameter indicating whether a random slot assignment is provided.

According to various embodiments, the restricted access window parameters may include or may be a periodic operation validity parameter indicating the number of periods the periodic operation of the restricted access window repeats.

According to various embodiments, the type parameter may indicate whether the restricted access window parameters are parameters for a regular restricted access window, for a power saving mode restricted access window, for a periodic restricted access window, or for a sounding restricted access window.

According to various embodiments, the type parameter may indicate whether the restricted access window parameters are parameters in which one or more of the following parameters are provided: start time indication; slot definition; same group indication; channel indication; periodic restricted access window periodicity; or periodic restricted access window start offset.

FIG. 1D shows a flow diagram 116 illustrating a method for controlling an access point according to various embodiments. In 118, restricted access window parameters may be transmitted. The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, the type of restricted access window parameters may include or may be restricted access window parameters indicating parameter for a plurality of restricted access windows.

According to various embodiments, the restricted access window parameters may include at least one common parameter for the plurality of restricted access windows.

According to various embodiments, the type parameter may include or may be a parameter of a subsequent restricted access window.

According to various embodiments, the restricted access window parameters may include a same group parameter indicating whether parameters for a restricted access window are valid for a group of radio communication devices identical to a group of radio communication devices, for which the previous restricted access window parameters are provided.

According to various embodiments, the type parameter may include or may be a parameter indicating whether the restricted access window parameters define a pre-determined default operation mode.

According to various embodiments, the restricted access window parameters may include or may be a parameter indicating whether a random slot assignment is provided.

According to various embodiments, the restricted access window parameters may include or may be a periodic operation validity parameter indicating the number of periods the periodic operation of the restricted access window repeats.

According to various embodiments, the type parameter may indicate whether the restricted access window parameters are parameters for a regular restricted access window, for a power saving mode restricted access window, for a periodic restricted access window, or for a sounding restricted access window.

According to various embodiments, the type parameter may indicate whether the restricted access window parameters are parameters in which one or more of the following parameters are provided: start time indication; slot definition; same group indication; channel indication; periodic restricted access window periodicity; or periodic restricted access window start offset.

FIG. 1E shows a flow diagram 120 illustrating a method for controlling a radio communication device according to various embodiments. In 122, restricted access window parameters may be received: The restricted access window parameters may include at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

According to various embodiments, the type of restricted access window parameters may include or may be restricted access window parameters indicating parameter for a plurality of restricted access windows.

According to various embodiments, the restricted access window parameters may include at least one common parameter for the plurality of restricted access windows.

According to various embodiments, the type parameter may include or may be a parameter of a subsequent restricted access window.

According to various embodiments, the restricted access window parameters may include a same group parameter indicating whether parameters for a restricted access window are valid for a group of radio communication devices identical to a group of radio communication devices, for which the previous restricted access window parameters are provided.

According to various embodiments, the type parameter may include or may be a parameter indicating whether the restricted access window parameters define a pre-determined default operation mode.

According to various embodiments, the restricted access window parameters may include or may be a parameter indicating whether a random slot assignment is provided.

According to various embodiments, the restricted access window parameters may include or may be a periodic operation validity parameter indicating the number of periods the periodic operation of the restricted access window repeats.

According to various embodiments, the type parameter may indicate whether the restricted access window parameters are parameters for a regular restricted access window, for a power saving mode restricted access window, for a periodic restricted access window, or for a sounding restricted access window.

According to various embodiments, the type parameter may indicate whether the restricted access window parameters are parameters in which one or more of the following parameters are provided: start time indication; slot definition; same group indication; channel indication; periodic restricted access window periodicity; or periodic restricted access window start offset.

According to various embodiments, devices and methods to support efficient MAC (medium access control) operation in IEEE 802.11-based networks may be provided.

In the following, channel access for a non-TIM (non traffic indication map) station will be described.

A procedure for a STA that doesn't listen to the beacon to reschedule its awake/doze cycle may be defined.

A low power STA can send a PS-Poll/trigger frame any time to its associated AP upon waking up without listening to the beacon. The low power STA can be a non-TIM STA.

Upon receiving the PS-Poll/trigger frame, AP may respond with a control frame with a timer. The control frame can be short ACK (acknowledgement) frame or modified short ACK frame, which uses the Duration field to indicate wakeup timer when Duration Indication field is set to 1. The STA can re-synchronize to the beacon with the help of the timer. The short ACK frame may contain a buffered data indication in More Data field for the low power STA. When the low power STA identifies there is no buffered frame for itself (More Data field is 0), it can go to sleep. If the low power STA identifies there is any buffered frame for itself (More Data field is 1), it may go to sleep but may wake up again after the timer expires.

AP may set the timer (Duration field) as the duration to the next TBTT (target beacon transmission time) in the responding NDP (null data packet) ACK frame and treat the non-TIM STA as a TIM STA starting from the next TBTT. When the timer expires, the dozing low power STA may wake up to receive the beacon and operate as a TIM STA. The STA returns to the non-TIM STA operation mode if the AP indicates that there is no more data buffered for the STA and the STA indicates to the AP that there is no more data to transmit. The AP treats the STA as a non-TIM STA if the STA indicates that there is no more data to transmit and the AP indicates that there is no more data buffered for the STA. If AP sets the timer to 0, it indicates that there is no sleep duration for the low power STA.

AP may respond to the active polling from the unscheduled STA with timestamp and change sequence. If the timestamp indicated in the response to active polling message may help the STA to resynchronize with the AP's timestamp. The non-TIM STA can wake up at the intended time with little clock drift and may turn into TIM operation mode and listen to the beacon and/or align to the boundary of its slot assigned by the AP.

The question may be: can non-TIM STA make efficient use of TIM-RAW (wherein RAW may stand for restricted access window) based channel access after temporarily mode switching? The challenge is that TIM indication is page-based and if non-TIM STA switches its mode temporarily and its TIM bit should be indicated in the TIM IE of the beacon, non-TIM STAs at different pages may not be able to receive their TIM bits at the next TBTT when only one page is allowed in one beacon. If multiple-page TIM IEs are allowed, the non-TIM STA is able to receive its TIM bit in the next TBTT after temporary mode switching. Raw Parameter Set (RPS) IE and Segment Count IE consider only TIM STA for RAW operation. TIM page/segment doesn't schedule mode-changing non-TIM STA. It is costly for non-TIM STA to receive every TIM segment arrangement. Therefore, some change are required to support TIM-RAW based channel access for mode-changing non-TIM STA.

There may be a few options to support low power operation of non-TIM STA.

A first option is that we can include multi-page TIM IEs in one beacon. This method has some advantages, for example, temporary mode-switching non-TIM STA can follow TIM STA's channel access method to receive downlink (DL) data. The disadvantage is that RPS IE should support temporary mode-changing non-TIM STA and needs modification i.e. support multi-page STAs for different RAW groups. Otherwise, we need to include RPS IE for multi-page STAs in one beacon.

A second option could be Virtual TIM Segment for non-TIM STAs (details see following description). The method may have the advantage that we can make use of TIM page/segment concept with some change. However, the disadvantage is that it may be inflexible when non-TIM STAs change their mode permanently and/or AID (association identifier) is re-assigned and/or TIM and non-TIM STAs are associated with the same AP. In this scheme, the information of virtual TIM segment and virtual RAW slot allocation is usually fixed and not required to be transmit at every beacon unless there is a difference between the original and current virtual RAW slot assignment or between the original and current virtual TIM segment.

In the following, a virtual TIM Segment will be described.

In this scheme, we regard non-TIM STA as TIM STA for virtual TIM segment but without TIM indication in TIM IE unless it temporarily changes its non-TIM mode to TIM mode. If no TIM bit is set, no TIM IE is required. Normally, each segment for non-TIM STAs is virtually associated with one beacon or one beacon interval (BI) and each non-TIM STA (AID) is associated with one virtual TIM segment. Non-TIM STA may re-synchronize with the TBTT with which its TIM segment is associated. The scheme is with little overhead but with the almost static assignment and the latency could be more than one beacon interval (BI). If a non-TIM STA is allowed to associate with more than one AID (AID for unicast and MID for multicast), it may be associated with more than one virtual TIM segment in which the non-TIM STA should have one assigned AID. Segment Count IE may be used to provide the assignment of page segments among multiple TIM segments and indicate the assignment to non-TIM STAs in allocated page segments. If there is no change for TIM segment assignment, Segment Count IE is not required in DTIM beacon. The TIM Segment assignment may be determined through other frame exchange or association phase and may be associated with the DTIM Count value of TIM IE in which the DTIM Count field indicates how many Beacon frames (including the current frame) appear before the next DTIM. A DTIM Count of 0 indicates that the current TIM is a DTIM. The DTIM count field is a single octet. For example, if DTIM period is 10 beacon intervals, the TIM segment is associated with the beacon with the DTIM Count value of 0 and N^{th} (N<10) TIM segment is associated with the beacon with the DTIM Count value of N. If virtual TIM segment contains unequal number of non-TIM STAs for the beacon intervals, the frames other than Segment Count IE in DTIM beacon may be used to indicate the virtual TIM assignment for the non-TIM STAs.

In the following, a virtual RAW slot assignment will be described.

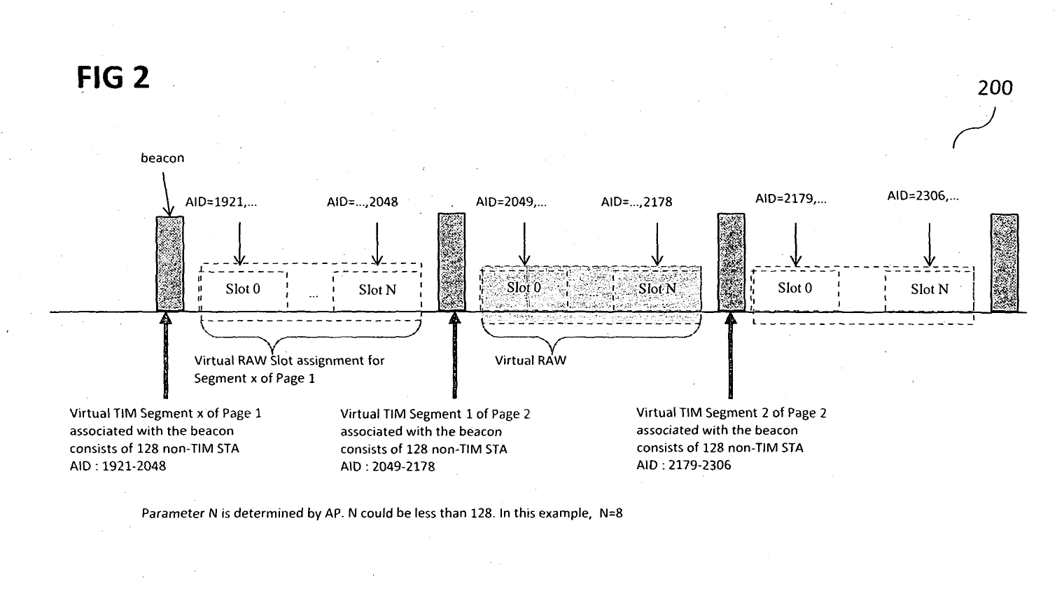

Default RAW Parameter Set IE may be used for the channel access of temporary mode-change non-TIM STAs. Slot allocation approach according to IEEE may be reused to allocate and indicate the virtual RAW, which is allocated to a RAW group including the non-TIM STAs for their channel access. However, if there is no change, RPS IE is not required to appear in the beacon. In this case, the pre-arrangement of RAW in the beacon interval is known to both AP and the non-TIM STAs, if the beacon contains no RPS IE. The RAW Start Time subfield indicates the duration, e.g. in TU, from the end of beacon transmission to the start time of the RAW. If the beacon size and transmission rate is not changed, the start time of virtual RAW can be fixed. Virtual RAW duration and slot duration are typically fixed. If a change on RAW duration or slot duration/starting or slot allocation is required, RPS IE may be used in the beacon to indicate the assignment. Multiple non-TIM STAs may share the same slot virtually if there are fewer slots than the number of non-TIM STAs associated with the indicated TIM segment. The example in FIG. 2 (like will be described in more detail below) illustrates that 128 non-TIM STAs virtually share the 8 time slots in one RAW which is assigned to a virtual TIM segment associated with one beacon interval of which the assignment may be indicated by TIM Segment Count IE in DTIM beacon. Upon AP determining there will be collision in one slot for more than one mode-changing non-TIM STA, AP may indicate in the RPS IE explicitly to avoid collision.

In RAW, the STA may determine the index of the time slot, iₛₗₒₜ, in which the STA is allowed to start accessing the medium based on the following mapping function:

iₛₗₒₜ=(x+N_{offset}) mod N_{RAW}

where,

if the RAW is restricted to STAs whose AID bits in the TIM element are set to 1, x is the position index of the AID of the STA when the AIDs are arranged in ascending order and each AID is assigned with a position index, which starts from 0; x is the AID of the STA, otherwise;

N_{offset} represents the offset value in the mapping function, which improves the fairness among the STAs in the RAW, and the FCS field or the Timestamp field of the Beacon frame shall be used for the N_{offset};

mod X indicates the modulo X operation.

However, though RPS IE (information element) is not required in the beacon if there is no change, the temporary mode-changing non-TIM STA receives the beacon to obtain N_{offset} to achieve the fairness on the accessing to the slots after the wakeup timer or other equivalent time information indicated in the response to unscheduled PS-Poll/trigger frame expires. If the non-TIM STA can't obtain N_{offset}, the time information carried in the response to unscheduled PS-Poll/trigger frame points to the starting of the assigned virtual slot(s) for the virtual TIM segment.

The virtual RAW slot assignment is different from the concept of TWT (Target Wake Time). The main purpose of this scheme is for long sleep STA with clock drift that can't synchronize their wakeup time with the beacon transmission time. Therefore, the long sleep STA will send PS-Poll/trigger frame when wake up without listening to the beacon, and once is responded by the AP with a timer indication or other equivalent time information to re-synchronize with the TBTT, it can access its RAW and assigned time slot in the RAW properly. The first step for long sleep STA is to re-synch with the TBTT. Due to N_{offset} that is used to randomize the slot assignment for the RAW operation to achieve the fairness, the virtual slot assignment may not be fixed for the non-TIM STA. In this sense, the virtual slot assignment is different from TWT as the assigned virtual slot for a particular non-TIM STA may be changed due to the different N_{offset} in the beacons.

However, RPS IE is not required to be included in the beacon if only the parameter N_{offset} (but not the starting time of virtual RAW, slot duration and TIM segment) is different from the earlier assignment (i.e., virtual TIM segment and virtual slot assignment) for the beacon interval. RPS IE may be used when there is a change on RAW duration or slot duration/starting. For example, slot duration could be changed or a RAW is setup for TIM STAs associated with the same AP. If there is a broadcast traffic delivery immediately after DTIM (delivery traffic indication message) beacon and there is no enough space between the end of beacon transmission and the starting of the virtual RAW, the virtual RAW start time has to be changed. If it happens that there will be a non-TIM STA accessing to its assigned virtual slot in its virtual RAW, such change leads to the channel access time change in the beacon interval and RPS IE can be used to indicate the RAW and slot assignment for the non-TIM STA that was rescheduled to listen to the beacon and will operate at TIM mode temporarily after wakeup on TBTT.

In the following, indication for virtual TIM segment and virtual RAW slot assignment will be described.

The virtual TIM segment (page and segment) and virtual RAW slot assignment can be indicated through association, management frame exchange or beacon frame.

If there is an AID re-assignment, individual management frame exchange between AP and STA can be used to complete the re-assignment of virtual TIM segment & slot assignment. The (re)-assignment method for virtual TIM segment and slot assignment may be through other mechanism.

First time virtual TIM segment and virtual RAW slot assignment for non-TIM may be done through association.

If there is virtual TIM segment arrangement change, it can be indicated through DTIM beacon.

If there is virtual RAW slot assignment (starting of the slots and/or slot duration) change, it is indicated at the broadcast/group frame or beacon or other frames.

TIM and temporary mode-switching non-TIM STAs may be allocated with the slots in the same or different RAWs.

RAW group for RA frame may include non-TIM STA which is in the same AID range as TIM STA if any.

The virtual RAW slot assignment is similar to the concept of assigning Target Wake Time (TWT) to the non-TIM STA which will wake up at TWT. However, virtual RAW slot assignment is mainly for the data transmission between AP and the non-TIM STA which wakes up in an earlier time before accessing to the assigned virtual slot. TWT is for non-TIM STA with small clock drift while virtual slot assignment is for the non-TIM STA that may sleep much longer time with larger clock drift disabling the synchronization with its AP's timestamp.

In the following, response to PS-Poll/Trigger Frame will be described.

FIG. 2 shows an illustration 200 of an example of virtual TIM segment & (and) virtual RAW slot assignment.

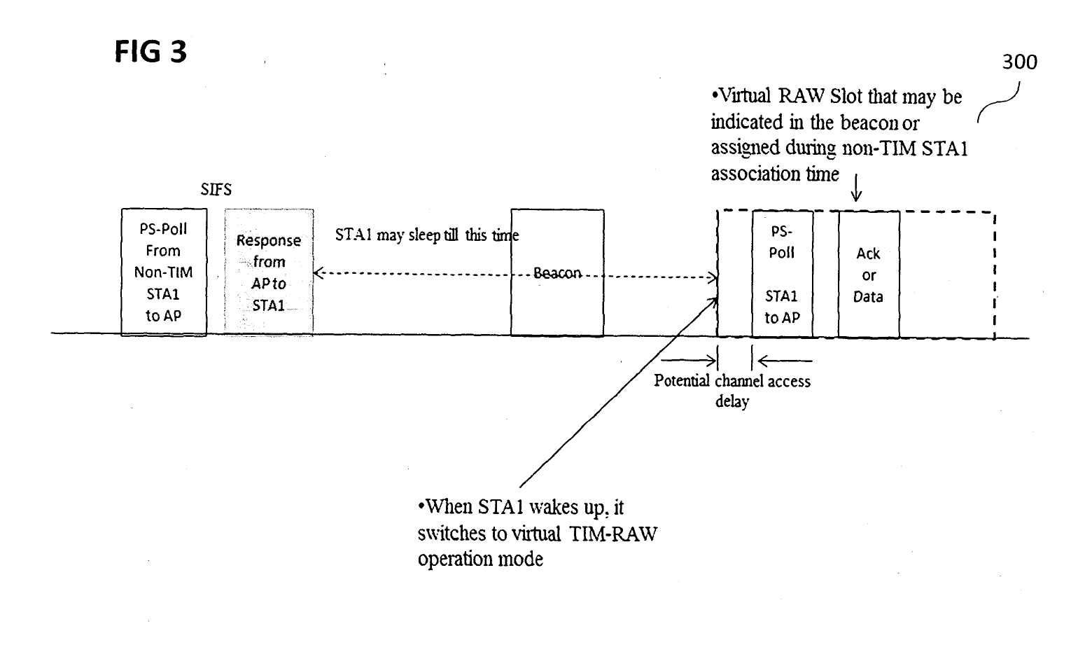

FIG. 3 shows an illustration 300 of an example of virtual RAW slot where non-TIM STA sends PS-Poll again and AP responds to the non-TIM STA after the wakeup timer expires.

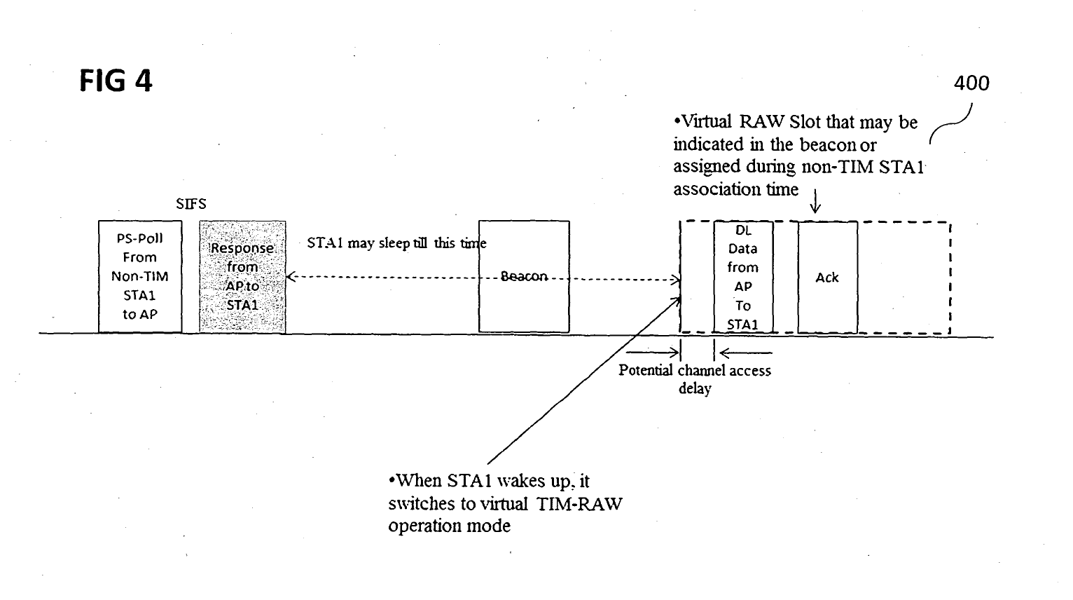

FIG. 4 shows an illustration 400 of an example of virtual RAW slot assignment where AP immediately sends data to the non-TIM STA after the wakeup timer expires.

Devices and methods may be provided to set the time indicated to receive/transmit data frame.

AP may indicate the time in the response to non-TIM STA's PS-Poll/trigger frame where the time could point to TBTT, an assigned slot in RAW operation, its TWT (Target Wake Time) or open access window (if the starting time is fixed or known). Latency can be reduced without re-synch to next TBTT/associated TBTT (associated TBTT is the TBTT that its virtual TIM segment is associated with).

The indicated time could point to TBTT as in the description of our earlier TD. After the long sleep STA listens to the beacon, it can start to follow TIM-RAW or virtual TIM-RAW based channel access.

If the STA is allocated with TWT, the indicated time could point to the low power non-TIM STA's TWT. In this case, virtual TIM segment/RAW/slot assignment is not applicable.

The indicated time could be Open Access Window, which sets a bit in RAW PS IE or the beacon to indicate there will be data frame transmission at the beginning of open access window (suitable for only one transmission). In some cases, the indicated time could only point to the starting of open access window that starts at the closest future time to satisfy its required latency. If there is a latency requirement, AP may indicate the non-TIM STA to wake up at the starting of an earliest future open access window if the duration to the respective virtual. RAW time slot or TWT of the non-TIM STA is large than the required maximum latency.

The indicated time points to Virtual RAW slot that is assigned to the non-TIM STA. Each non-TIM STA is allocated to into a Virtual RAW group in a beacon interval or some beacon intervals. RAW starting time could be fixed. RAW slot allocation could be fixed. RAW PS IE may not be required for each beacon unless the parameter changes. FIG. 1.2 shows one example for the virtual TIM-RAW channel access through a Virtual RAW Slot where non-TIM STA sends PS-Poll again and AP responds to the non-TIM STA after the non-TIM STA sleeps for a period of time. A wakeup timer may be carried in the response frame to the first PS-Poll sent by STA1 upon the STA1 wakes up for some channel access delay time. The virtual TIM-RAW channel access is different from TIM-RAW channel access in that there is no RPS IE for the RAW group including the non-TIM STA (temporary mode-changing to TIM mode) in TIM IE and the non-TIM STA can still access to the channel according to the virtual TIM segment arrangement and virtual slot assignment in the earlier time.

Alternative, if the timestamp is carried in the response to the PS-Poll/trigger frame from the long sleep STA, the long sleep STA can go to sleep and directly access to the channel after waking up again. Note that the sleep time for the long sleep STA is determined by the difference of timestamp it stores and the timestamp it receives from AP's response to its PS-Poll/trigger frame. Once the difference is known, the long sleep STA can calculate the duration to its associated TBTT from which the virtual RAW and virtual slot assignment can be determined. FIG. 3 shows that if the timestamp is carried in the response to non-TIM STA's PS-Poll, the non-TIM STA may be able to calculate the difference between its stored timestamp and the received timestamp from its associated AP, and then go to sleep for a duration after which it wakes up at its assigned virtual slot in the virtual RAW to which its virtual TIM segment is assigned and send PS-Poll again to pull the buffered data from its AP.

Non-TIM STA receives AP's response that reschedules it to wake up at a time when Resource Allocation (RA) frame is broadcast (i.e., the starting time of RAW for which RA frame is the first frame) after sending PS-Poll/trigger frame. It can get channel access within current beacon interval without re-synch to next TBTT (not required to listen to the beacon). Resource Allocation frame is broadcast at the assigned time (e.g. starting of a RAW).

Sometimes, a non-TIM STA may be directed to a beacon that is not for its own TIM segment when it is allocated during association or other (management) frame exchange to determine its virtual TIM segment. In this case, a proper virtual TIM segment indication should be carried either at the beacon or other frame to the non-TIM STA. However, this change is temporary for once only and should not be recognized as a permanent change through the re-assignment of virtual TIM segment/slot assignment.

If AP sends the time information in the response to non-TIM STA's PS-Poll/trigger frame and the time points to the slot boundary, upon the non-TIM STA waking up after rescheduling the doze/awake cycle, AP may send synchronization frame to assist the non-TIM STA to synchronize with the slot boundary. Alternatively, non-TIM STA may send additional frame to request the resynchronization with AP.

If the response includes the wakeup timer or sleep duration information, the information contains the difference between the associated TBTT and the value of the transmitting STA's TSF timer (timestamp) at the time that the data symbol containing the first bit of the timestamp is transmitted to the PHY plus the transmitting STA's delays through its local physical layer (PHY) hardware from the MAC-PHY interface to its interface with the wireless medium (e.g. antenna, light emitting diode (LED) emission surface). The TBTT is the time that the data symbol containing the first bit of the beacon is transmitted to the PHY plus the transmitting STA's delays through its local physical layer (PHY) hardware from the MAC-PHY interface to its interface with the wireless medium.

If the response includes the timestamp information, the information contains the full or least significant X (e.g. X=4) octets of the value of the transmitting STA's TSF timer (timestamp) at the time that the data symbol containing the first bit of the timestamp is transmitted to the PHY plus the transmitting STA's delays through its local physical layer (PHY) hardware from the MAC-PHY interface to its interface with the wireless medium.

If the assigned virtual RAW and time slot is or will be used by new TIM STAs, upon sending PS-Poll/trigger frame and receiving the response from the AP, the non-TIM STA may be directed to the beacon (i.e. scheduled to next or a suitable TBTT) where a new RPS IE is specified for both TIM and the non-TIM STA (temporary mode-switching to TIM STA) and this non-TIM STA can follow the RAW operation according to the information in the beacon (e.g. TIM IE, RPS IE, FCS of the beacon). In this situation, since the virtual slot assigned to the non-TIM STA will be used by TIM STAs for a long time, the AP had better re-assign to the non-TIM STA a new AID and/or to a new virtual TIM segment so that the non-TIM STA can perform virtual TIM-RAW channel access without re-synch to the beacon (TBTT). Otherwise, since non-TIM STA may go to sleep after the data transmission in the beacon interval and TIM STAs may de-associate with AP, AID re-assignment and/or re-allocation of virtual RAW/slot is not required.

If the assigned virtual RAW and time slot is or will be used by new TIM STAs, upon sending PS-Poll/trigger frame and receiving the response from the AP, the non-TIM STA may be directed to the beacon (i.e. scheduled to next or a suitable TBTT) where the non-TIM STA can access the open access window (the channel access time not in the RAW), or may be directed to the starting time of open access window in the same beacon interval.

Alternatively, if new TIM STAs can be allocated to a RAW without overlapping with the virtual slot(s) assigned to an existing non-TIM STA, the non-TIM STA is not required to re-synch with the beacon to capture the new RPS IE. For example, AP may assign a certain percentage of beacon interval as the virtual RAW to the non-TIM STAs and reserve some channel access time other than virtual RAW for TIM STAs.

FIG. 4 shows one example for the virtual TIM-RAW channel access through a Virtual RAW Slot where non-TIM STA sends data immediately without sending PS-Poll again after the indicated timer expires. The timer is carried in the response frame to the PS-Poll sent by STA1 upon the STA1 wakes up for some channel access delay time.

The above mechanism of AP sending time information in the response to the long sleep STA's initial frame after wakeup is not limited to PS-Poll/trigger frame (e.g. The frame could be the active polling message, if the polling message is different from PS-Poll. The frame could be NDP MAC frame format for PS-Poll).

In the following, group addressed traffic delivery will be described.

Multicast AID (MID) may be provided to support the traffic delivery to a group of STAs that belong to the same multicast group. When the group of STAs joins a multicast group, a multicast AID other than individual AID is also assigned to the STA that is a member of the multicast group. However, how to deliver the traffic from AP to the multicast group of STAs is not specified.

Due to power saving and TIM-RAW access, when the multicast traffic is indicated through TIM bit for the multicast AID, the multicast group is designed to wake up at the time slots allocated to the multicast AID in the RAW group. We may have a few options to support the delivery.

A first option may be that AP may deliver the traffic for multicast AIDs in a separate RAW that is different from the one for unicast downlink/uplink traffic. This RAW is for multicast traffic delivery only and can allocate the time slots for different MIDs either explicitly through a Resource Allocation frame or an implicit, time slot allocation. In both cases, the STA should identify the slots for its own MID so that it can go to sleep in other slots and wake up at its own slots to receive MID traffic. To let the STA identify the exact time, slot for its MID traffic, the implicit time slot allocation) through the MID indication in TIM IE is simple but the AID range for the MID should be known by the AID group in the RAW. For example, AP may specify that some AIDs in the RAW group are reserved to MIDs explicitly through some signaling frames or the beacon.

FIG. 5 shows an illustration 500 of the separate RAWs for unicast and multicast traffic delivery. Assume STA1 is not in the multicast group and has no MID associated with it while STA2 is in the multicast group and there is one MID associated with it. In FIG. 5, it is assumed the MID TIM bit for STA2 is set to 1 and MID traffic delivery in RAW1 is indicated in RPE IE in the beacon. RAW2 is for the STAs (STA1 and STA2) in the RAW group to send PS-Poll while Resource Allocation frame (RA frame) is transmitted at the beginning of RAW3 to indicate there are two slots (may be with different duration) allocated to STA1 and STA2 respectively. Thus, STA1 is not required to wake up in RAW1 but it wakes up to send PS-Poll in RAW2 and receives RA frame and downlink (DL) data only in its time slot (slot 1) in RAW3. STA2 wakes up in RAW1 to receive MID traffic and sends its PS-Poll in RAW2 and receives RA frame and downlink (DL) data in only its time slot (slot 2) in RAW3.

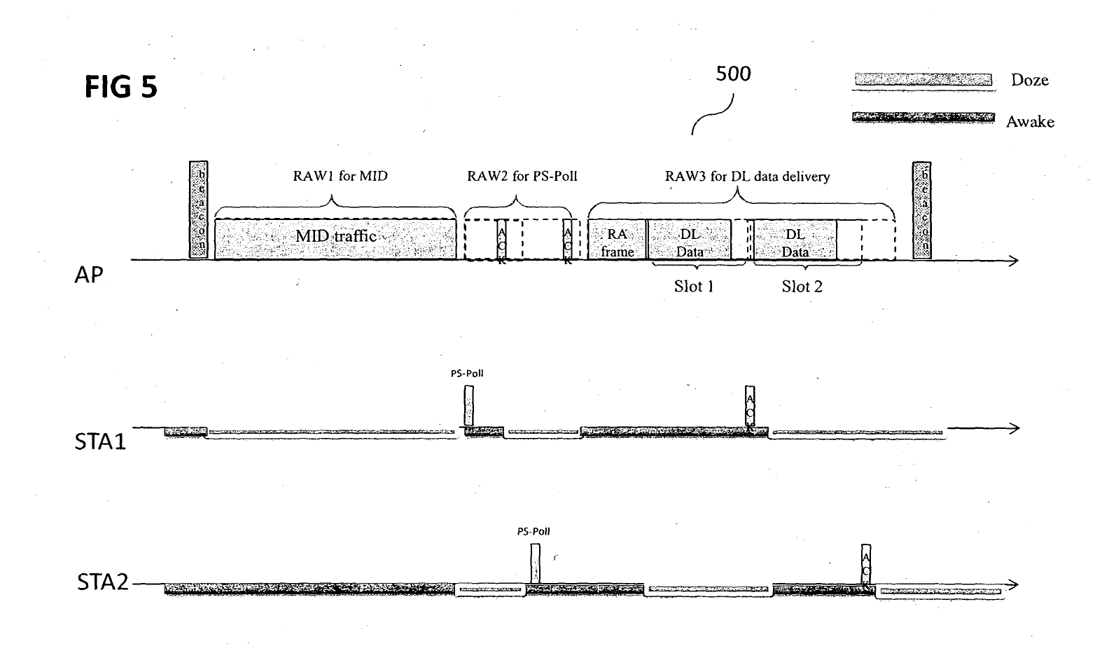

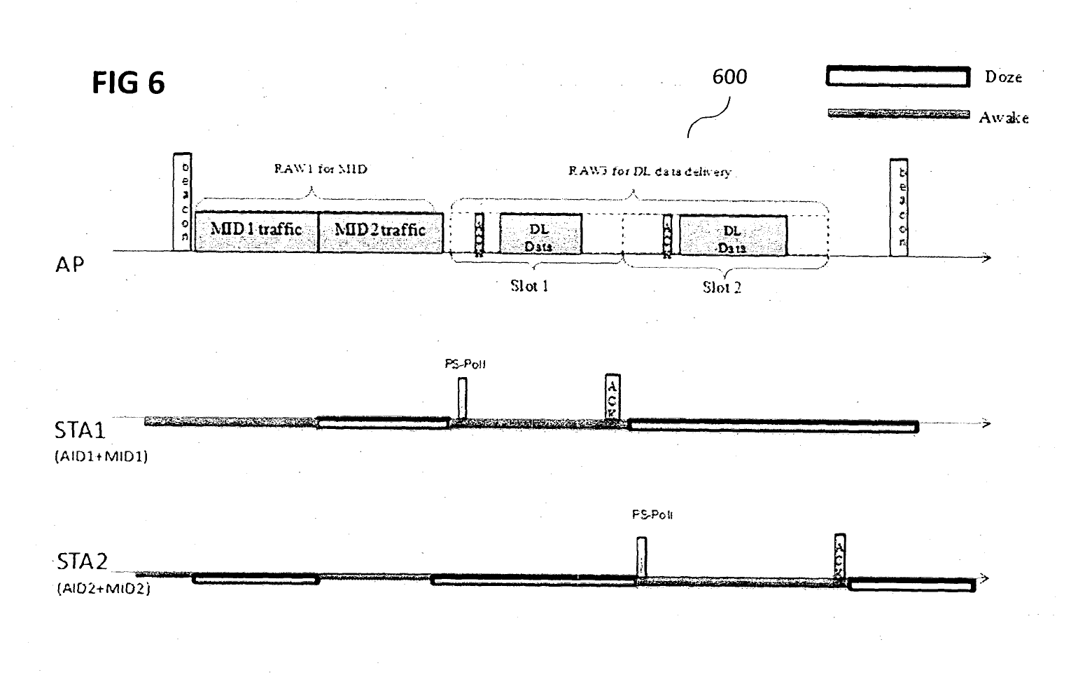

FIG. 6 shows an illustration 600 of the separate RAWs for unicast and multicast traffic delivery. Assume STA1 with AID1 is associated with multicast group MID1 while STA2 with AID2 is associated with multicast group MID2. In FIG. 6, it is assumed the TIM bits for MID1 and MID2 as well as AID1 and AID2 are set to 1. MID traffic delivery in RAW1 is indicated in RPE IE in the beacon and slot assignment is based on an implicit time slot allocation. Thus, once STA1/STA2 know that MID1 and MID2 are for multicast AID, it can sleep in the slot that is not used for its own MID but wake up at the slot for its own MID. RAW2 is used for the STAs (STA1 and STA2) in the RAW group to send PS-Poll to pull the buffered frame from the AP, where slot assignment is also based on the implicit time slot allocation.

A second option may be that AP may deliver the traffic for multicast AIDs in a RAW that is also for unicast downlink/uplink traffic. In this case, AP can indicate a few reserved slots for MID traffic and exclude unicast traffic from accessing these reserved slots. If there are more than one MID traffic to be delivered in one RAW, to save the power (the STA only wakes up at its MID slot), an explicit indication of AID range reserved for MIDs should be indicated to the STAs in the RAW group explicitly through some signaling frames or the beacon. Otherwise, if AP indicates the slot assignment through Resource Allocation frame, it can indicate the slots for MID traffic explicitly.

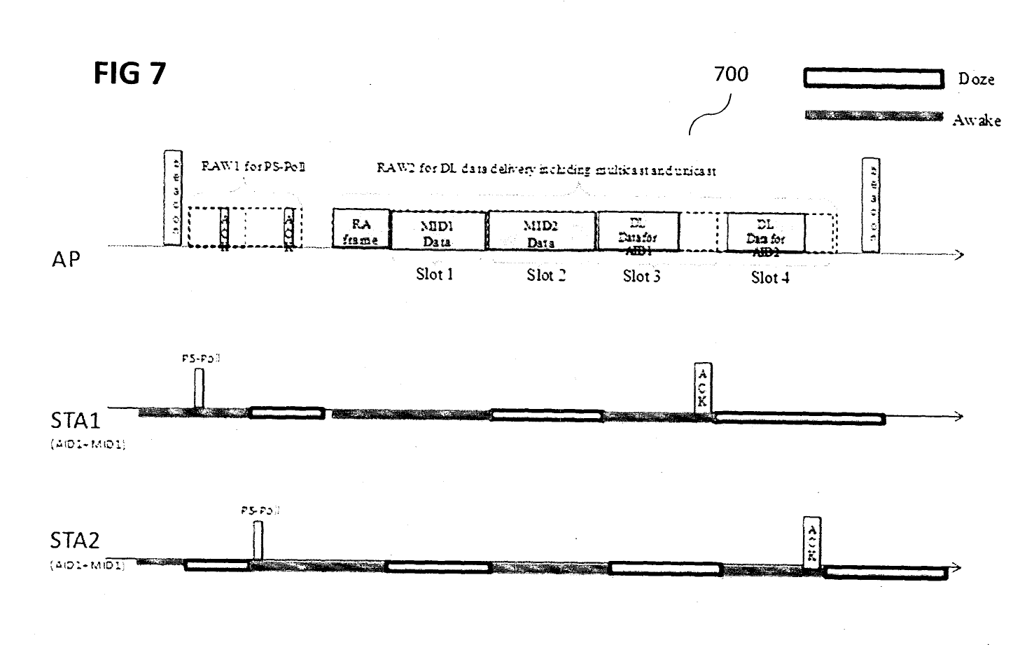

FIG. 7 shows an illustration 700 of the combined RAW for unicast and multicast traffic delivery. Assume STA1 with AID1 is associated with multicast group MID1 while STA2 with AID2 is associated with multicast group MID2. In FIG. 7, it is assumed the TIM bits for MID1 and MID2 as well as AID1 and AID2 are set to 1. RAW1 is for the STAs (STA1 and STA2) in the RAW group to send PS-Poll while RAW2 is used for traffic delivery and Resource Allocation frame (RA frame) is transmitted at the beginning of RAW2 to indicate there are four slots (may be with different duration) allocated to MID1, MID2, AID1 and AID2 respectively. Thus, STA1 is not required to wake up in slot 2 and 4 in RAW2 but it wakes up to receive RA frame and downlink (DL) data only in its time slot (slot 1 and 3) in RAW2. STA2 is not required to wake up in slot 1 and 3 in RAW2 but it wakes up to receive RA frame and downlink (DL) data only in its time slot (slot 2 and 4) in RAW2.

A third option may be that AP may deliver the traffic for multicast AIDs immediately after the beacon. This method regards the MID traffic as broadcast. If there is only one MID with its TIM bit set to 1 in the TIM IE, it is convenient. However, when there is more than one MID with their TIM bits set to 1, the STA may waste its power to keep waiting for its MID traffic.

A fourth option may be that AP may deliver the traffic for one multicast AID immediately after each beacon and which MID traffic is delivered is indicated through DTIM beacon. This design is not flexible as when the number of MID grows, the DTIM interval has to increase. The MID traffic delivery is also limited to the fixed delivery interval and may not meet the latency requirement.

In the following, EDCA (Enhanced distributed channel access) backoff procedure in PRAW (periodic RAW) will be described.

PRAW is a series of RAWs that are allocated to one or a group of non-TIM STAs in a periodic manner with identical resource allocation. An AP may indicate to TIM STAs information of scheduled RAW during which no TIM STAs are allowed to contend, and PRAW can be used for this purpose. An AP may schedule and indicate TWT for a non-TIM STA within the PRAW duration in periodic manner, when the STA is associated with the AP or reschedule is needed. By allocating PRAW only for one or a group of STAs that an AP scheduled TWT, the AP can indicate to TIM STAs information of periodically scheduled RAWs during which no TIM STAs are allowed to contend.

For supporting the PRAW based on EDCA, a STA may maintain two backoff function states. First backoff function state is used in outside PRAW if it wakes up to access the channel and second backoff function state is used in inside PRAW. If the STA don't access the channel in non-PRAW period, it is not required to maintain non-PRAW backoff state. If the STA belongs to multiple different PRAWs, the backoff states for different PRAWs at the non-TIM STAs may be stored when the PRAW is not operated and restored when PRAW is operated, if the STAs in the PRAWs are different.

When a STA is allowed to contend in the PRAW, the STA suspends its backoff at the start of a PRAW and stores the backoff function state. At the end of PRAW, the previously stored backoff function state is restored and the backoff function resumes if the STA is awake and wants to access the channel. If the previously stored backoff function state is empty, the STA invokes a backoff procedure.

If a STA is participating in the PRAW, STA invokes the backoff function using the PRAW backoff parameters which may be different from non-PRAW backoff parameter. The backoff is also restored in a series of PRAW. If the previously stored backoff function state is empty, the STA invokes a backoff procedure. In the latter PRAW, the backoff function should resume the previously stored backoff state. This is due to there may be a group of STAs are assigned to the same series of PRAW.

If there is only one STA allowed to access to PRAW, the STA may invoke a new backoff function using the PRAW backoff parameters with an empty backoff state when it participate in the PRAW for channel access, i.e. it may not be required to store the backoff state for a series of PRAW. However, when there are new STAs participating in the same PRAW, the STA will be signaled by the AP to store the backoff state for a series of PRAW. The backoff state is not required to be stored if AP signals the STA can start the backoff with empty state due to that all other STAs in the same PRAW are no longer associated with the PRAW and the STA is the only one allowed to access to the PRAW.

The parameter such as CWmax for a group of STAs in the PRAW may be set to a smaller value since a long backoff large than PRAW duration may stop the STAs in the PRAW from getting channel access in the PRAW. Therefore, we can set a smaller CWmax PRAW parameter, taking into account the number of STAs participating in the PRAW. The parameter of backoff function PRAW can be indicated or setup through association or other frame exchange.

If the remaining time in the current PRAW is not enough to transmit data frame, the STAs may stop its backoff procedure to allow other STAs contending the channel for shorter frame transmissions and store the backoff state.

Alternatively, if the remaining time in the current PRAW is not enough to transmit data frame, the STAs may continue its backoff procedure till the end of PRAW and store the backoff state.

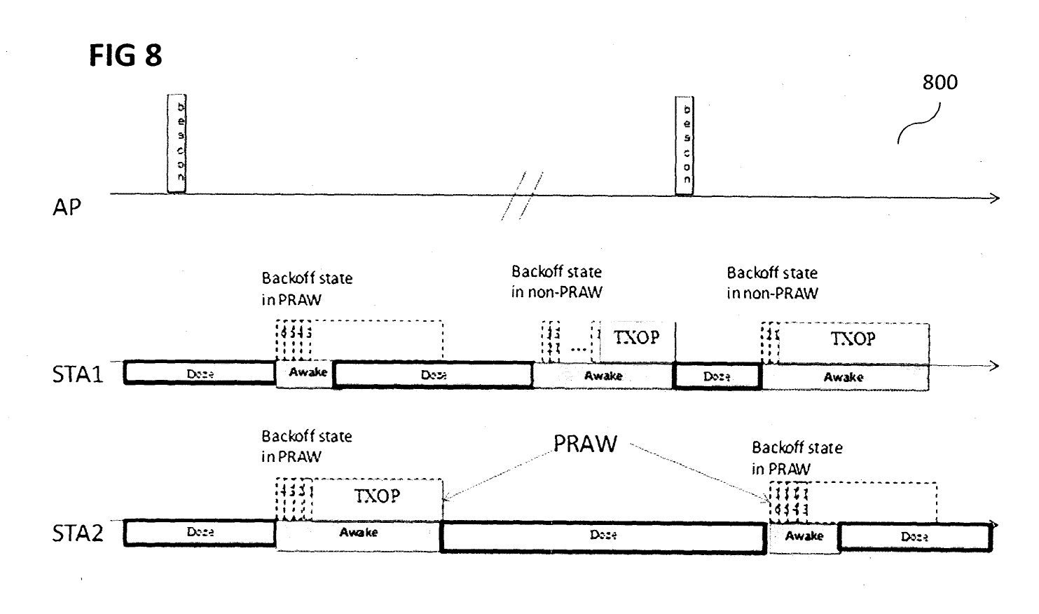

FIG. 8 illustrates the EDCA backoff procedure for PRAW where two non-TIM STAs i.e., STA1 and STA2 are allowed to access in the PRAW. Upon wakeup in the PRAW, STA1 and STA2 restore its backoff state in the PRAW and store the backoff state before the end of the PRAW. In the first PRAW, STA1 countdown its backoff state with backoff counter=6 and STA2 with backoff counter 4. STA2 starts to access the channel after the countdown counter reaches zero and STA1 stores the backoff state with the counter=3. In the second PRAW, STA1 wakes up and restore its backoff state with counter=3 and resumes its backoff until the counter reaches zero and then starts to access the channel, while STA2 starts its backoff state with the counter set to initial CW value (e.g. 16) and stores its backoff state as STA1 grips the channel.

In the following, RAW (restricted access window) operation according to various embodiments will be described.

RAW parameter set (RAW-PS) information element (IE) may be provided in the context of the IEEE 802.11ah standard, as shown in Table 1.

TABLE 1
RAW-PS IE format

| Feature | Value | | Interpretation |
|---|---|---|---|
| IE type | 8 | bits | Type of RAW-PS IE |
| IE length | 8 | bits | Length of IE |
| RAW Group | 24 | bits | Indicate range of AIDs included in the RAW |
| RAW Start | 8 | bits | Duration in TU (time units) from end of |
| Time | | | beacon transmission to RAW Start time |
| Access | 2 | bits | Bit 1: Set to 1 if only STA with their TIM bit |
| restricted | | | set to 1 are allowed to perform UL |
| to paged | | | transmissions |
| STA only | | | Bit 2: Set to 1 if RAW is reserved for frames |
| | | | with duration smaller than slot duration, such |
| | | | as PS-Polls/trigger frames (ignored if Bit 1 is |
| | | | not set) |
| Group/ | 1 | bit | Set to 1 to indicate if STAs need to wake up |
| Resource | | | at the beginning of the RAW to receive group |
| allocation | | | addressed frames such as resource allocation |
| frame | | | (format of the resource allocation frame TBD) |
| indication | | | |
| Slot | 16 | bits | Include |
| definition | | | Slot duration signaling |
| | | | Slot assignment to STA |

Cross boundary transmissions
allowed/not allowed
Format is TBD

The IE type and IE length may enable the receiving STA to properly identify and decode the RAW-PS IE. The subsequent fields may include the RAW definition and define the RAW operation. The page ID, block offset, and block range may define the RAW group, which is the group of STAs that are eligible to access the RAW. The subsequent fields may define the RAW operating parameters. The RAW start time and duration within the Beacon interval may be defined in RAW start time and RAW duration fields. The information may be necessary to prevent non-eligible STAs to access the RAW. It may be also necessary to eligible STAs (i.e. STAs in the RAW group) to determine their action properly. For example, they may go into sleep mode until the start of the RAW. They may also finish their transmission before the end of the RAW protection. The subsequent fields define the RAW option, which includes access restriction, group/resource allocation frame indication, and slot definition.

It may be desirable to shorten the Beacon to reduce the signaling overhead, and the size of RAW-PS IE may be reduced. One method to reduce the size of RAW-PS IE may be to combine the signaling information that is common to the operation of RAWs. Such common signaling information may include IE type, IE length, and RAW group.

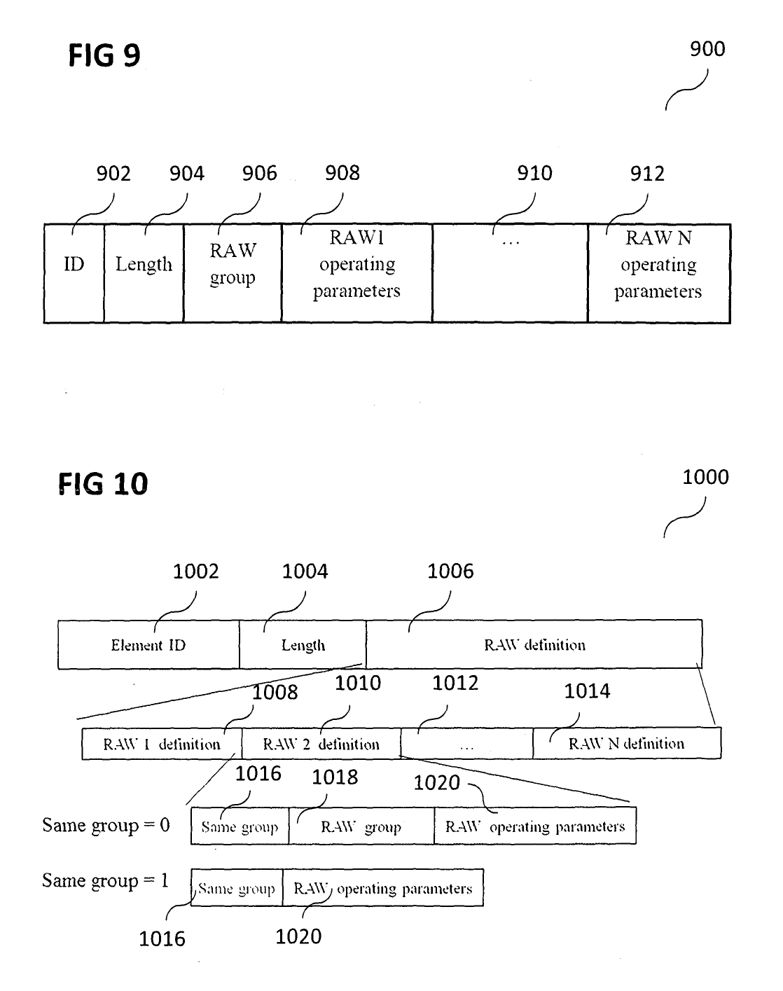

According to various embodiments, the RAW definition for STAs in the same RAW group may be combined within a Beacon interval into a single IE. This may be beneficial when the channel access for the same group of STAs span across multiple RAWs within the Beacon interval, where the first RAW may be used for PS-Poll/trigger frame transmission, and subsequent RAWs may be based on the Resource Allocation (RA) frame for data delivery. The definitions for these RAWs may be combined into a single IE that contains a common signaling field and a variable field. The common signaling field may include the signaling fields that are common in RAW definition, such as IE type (e.g. 902 in FIG. 9), IE length (e.g. 904 in FIG. 9), and RAW group information (e.g. 906 in FIG. 9). The variable field is of length S*N, where S is the size of each RAW operation parameter information in unit of bytes, and N is the total number of RAWs used in the Beacon interval. One example of the RAW-PS IE according to various embodiments is shown in FIG. 9.

FIG. 9 shows an illustration 900 of a RAW-PS IE format according to various embodiments. The RAW-PS IE may include an ID (identifier) field 902, a length field 904, a RAW group field 906, and a plurality of fields 908, 910, 912 for RAW operation parameters.

Based on the received RAW-PS IE, the receiving STA may first check if it is within the range of IDs defined in RAW group. If it belongs to the RAW group, it may be eligible to use the RAW for channel access, and it may read the following RAW operating parameters to determine usage of RAW. If the receiving STA does not belong to the RAW group, it may avoid accessing the RAWs defined in the RAW-PS IE in RAW start and RAW duration fields. It may access the channel outside these RAWs in the open access window (OAW).

According to various embodiments, a ‘same group’ indication may be added in each RAW definition for RAW group ID compression, as shown in FIG. 10.

FIG. 10 shows an illustration 1000 of a RAW-PS IE format according to various embodiments. An element ID field 1002, a length field 1004, and a raw definition field 1006 may be provided in the RAW-PS IE. The RAW definition field 1006 may include a plurality of RAW definitions, for example a RAW 1 definition field 1008, a RAW 2 definition field 1010, further RAW definition fields, like indicated by dots 1012, and a RAW N definition field 1014. Each of the RAW definition fields 1008, 1010, 1012, 1014 may have a similar or same structure. As an example, the structure for RAW 2 definition field 1010 is shown, in which a same group field 1016 may be provided and, if the same group field 1016 includes a value of 0, a RAW group field 1018 and RAW operating parameters field 1020 are provided, and if the same group field 1016 includes a value of 1, only the RAW operating parameters field 1020 (but not the RAW group field 1018) is provided.

To combine several RAW groups into the same RAW-PS IE, a ‘same group’ indication bit 1016 may be added to the RAW definition to indicate whether group ID in the current RAW definition is the same as previous one. When the same group indication bit 1016 is set to 1, it may indicate the group ID for current RAW definition is the same as previous one, and the group ID can be omitted. When the same group indication 1016 bit is 0, the group ID for current RAW definition is different from previous one, and group ID 1018 is present in current RAW definition. Regardless of the presence of RAW group, the same group indication bit 1016 is placed in a fixed location in the RAW definition and is known by all STAs.

Upon reception of the RAW-PS IE, a STA may first decode whether the ‘same group’ 1016 is set to 1 or 0. If the same group indication bit is 0, the STA may decode the subsequent field as RAW group. If the same group indication bit is 1, the STA may use the RAW group in the previous RAW definition as its current RAW group, and may decode the subsequent field as RAW operating parameters.

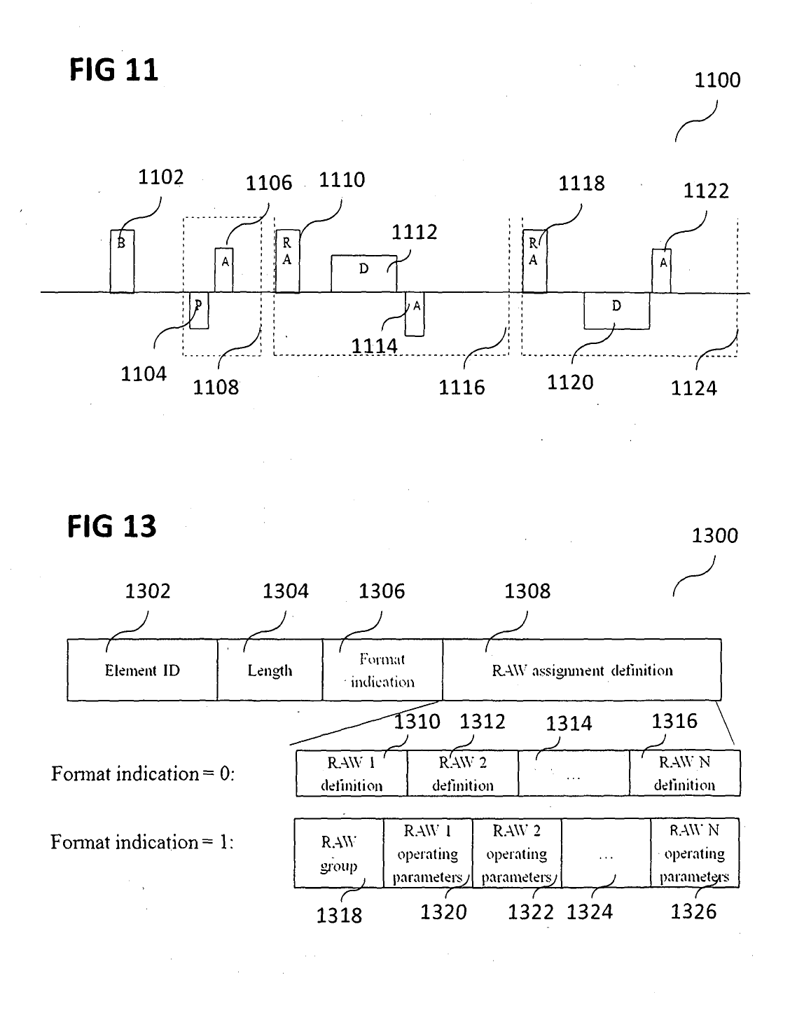

According to various embodiments, a default RAW operating mode may be provided. When multiple RAWs are used by the same group of STAs, the first RAW may be usually used for PS-Poll/trigger frame transmission, and the subsequent RAWs may be RA (restricted access)-based for data delivery for the same RAW group, as shown in FIG. 11. This can be considered as a default RAW operation mode.

FIG. 11 shows an illustration 1100 of an example of default operating mode according to various embodiments, wherein frames indicated by B may represent a Beacon, P a PS-Poll/trigger frame, A and ACK frame, D data, and RA and RA frame. Information sent by AP may be indicated above the horizontal line, and information sent by STA may be indicated below the horizontal line. For example, a beacon 1102 may be sent from AP. A PS poll frame 1104 may be sent from STA and may be acknowledged in 1106 by AP. An RA frame 1110 may be sent by AP, and data 1112 may be sent by AP and acknowledged in 1114 by STA. An RA frame 1118 may be sent by AP, and data 1120 may be sent by STA and acknowledged in 1112 by AP. Each dashed box 1108, 1116, and 1124 corresponds to one RAW.

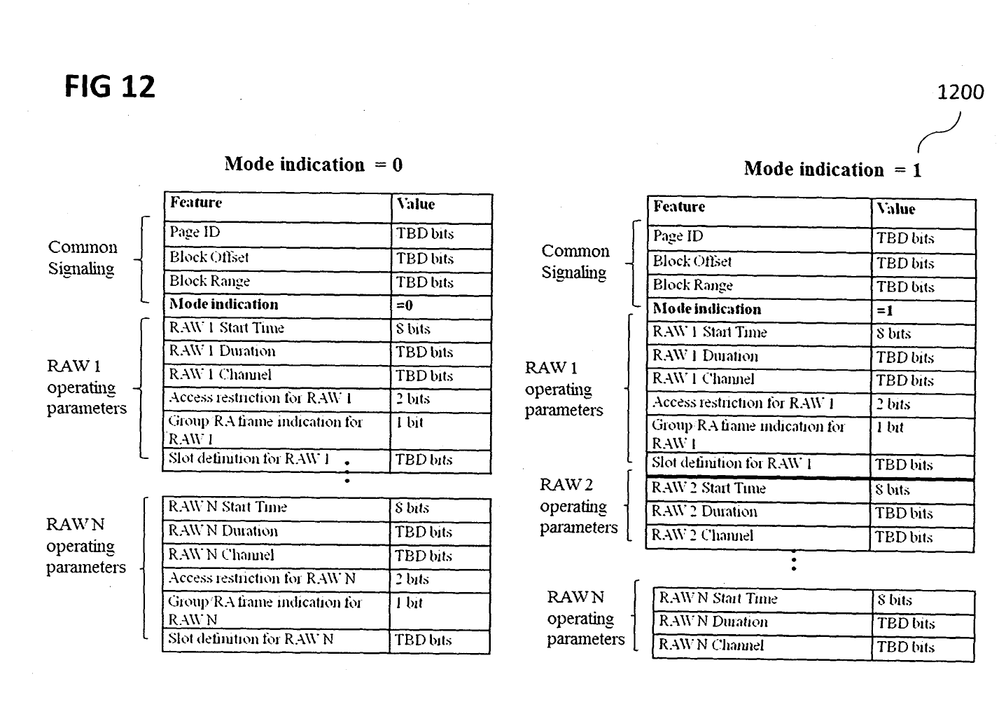

The operating mode may be indicated in a control field in RAW-PS IE. As resource allocation is done in subsequent RA frames, some fields such as the slot definition in RAW-PS IE may not be necessary and may be omitted. Hence the default mode may reduce signaling overhead. An example of RAW-PS IE to support default mode is shown in illustration 1200 of FIG. 12, where it is assumed a single mode indication bit is used in a field that contains common control signaling in RAW-PS IE. When mode indication bit is set to 1, the RAWs are defined for the default mode. The receiving STA may first decode the RAW group to check its eligibility. Eligible STA may continue to decode the RAW1 operating parameter, which assigns a slot for PS-Poll/trigger frame transmission. The STA further may decode the subsequent RAW operating parameters to find out the target RA frame transmission time and the corresponding RAW duration. It may sleep and only wake up at the RAW start time to receive the RA frame, which may further assign channel access slot for the STA. When mode indication is set to 0, the receiving STA may decode each RAW definition to check its eligibility and determine the RAW operating parameters. More modes may be supported with multiple operation mode bits.

According to various embodiments, a format indication may be added in control field to support several formats of RAW-PS IE. As the efficient signaling of RAW-PS IE depends largely on the RAW groups, the number of RAWs used for each group, and the channel access scheme, several formats of RAW-PS IE may be supported.

For example, the RAW-PS IE may define several RAW groups with different number of RAWs for each group. In this case, it may be efficient to use the same group indication to combine RAW definitions for the same group of STAs. On the other hand, when several RAWs are defined for a single group of STAs, it may be more efficient to combine the IE type, IE length, and STA group into the common signaling field. The format indication may be used to indicate whether the RAW-PS IE contains a single group of STAs, or multiple groups of STAs. More formats may be supported with more format indication bits.

FIG. 13 shows an illustration 1300 of an example of a single-bit format indication according to various embodiments. The RAW-PS IE may include an element ID field 1302, a length field 1304, a format indication field 1306, and a raw assignment definition field 1308. The receiving STA may first check the format indication bit 1306 in the common control signaling field to determine the format of the RAW-PS IE. When format indication 1306 is 0, it may decode each RAW definition 1310, 1312, 1314, 1316 separately to check its eligibility and operating parameters. The RAW definitions 1310, 1312, 1314, 1316 may be compressed using the ‘same group’ indication method described above. When format indication 1306 is 1, the STA may first decode the RAW group field 1318 to check its eligibility. It may further decode the RAW operating parameter fields 1320, 1322, 1324, 1326. Default operating mode as described above may also be indicated and supported.

The AP may indicate the presence of an RA frame at beginning of RAW by setting the ‘Group/RA frame indication’ bit to 1. Not all STAs in the RAW group need to wake up to receive the RA frame. For example, STAs without any uplink or downlink data need not check RA frame. Besides, STAs whose PS-Poll/trigger frames are not acknowledged by AP may not need to listen to RA frame, as AP may not be aware of the STA's power-saving status.

The AP may transmit group-addressed traffic in RAW. The scheduling of group-addressed traffic may be conveyed in the RA frame. In this case, all STAs in the RAW group may wake up to receive the RA frame and the group-addressed traffic.

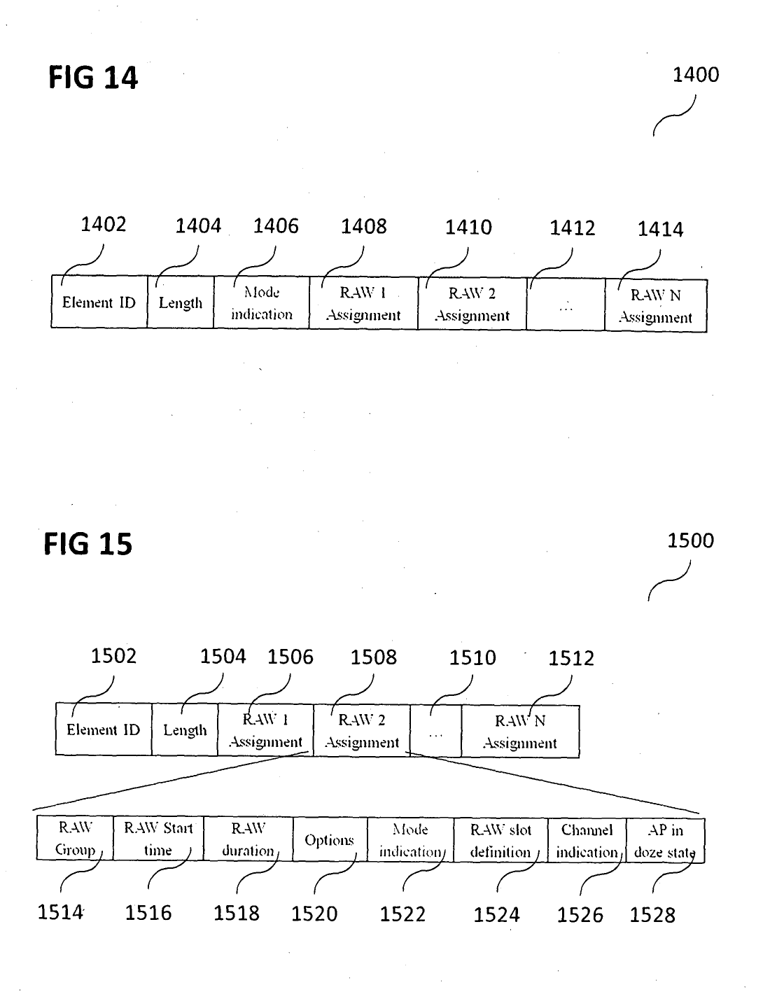

According to various embodiments, a RA mode indication bit may be added in the RAW definition. When the RA mode indication bit is set to 0, all STAs within the RAW group shall wake up to receive the RA frame defined in the RAW definition. When the RA mode indication bit is set to 1, only STAs that have successfully sent PS-Poll/trigger frame need to wake up to receive the RA frame. Possible formats of RAW definition are shown in FIG. 14 and FIG. 15. In one option like shown in FIG. 14, the RA mode indication may be added to a common control field. In the other option like shown in FIG. 15, the RA mode indication may be added to each RAW definition.

FIG. 14 shows an illustration 1400 of a RAW-PS IE with RA mode indication according to various embodiments, wherein the RAW operation mode indication is put into a common control field 1406 in RAW-PS IE. The RAW-PS IE may further include an element ID field 1402, a length field 1404, and a plurality of RAW assignment field 1408, 1410, 1412, and 1414. If mode indication 1406 indicates a zero-th mode (which may for example be referred to as Mode 0), all STAs in the RAW group shall listen to every group/RA frame defined in the RAW-PS IE for their RAW group in the current Beacon interval. If mode indication 1406 indicates a first mode (which may for example be referred to as Mode 1), only STAs that have successfully send PS-Poll/trigger frames need to wake-up and listen to subsequent RA frames defined in RAW-PS IE for their RAW group for data delivery in the current Beacon interval.

FIG. 15 shows an illustration 1500 of a RAW-PS IE with RA mode indication according to various embodiments, in which the RAW operation mode indication 1522 may be put into each RAW assignment definition. The RAW-PS IE may include an element ID field 1502, a length field 1504, and a plurality of RAW assignment fields 1506, 1508, 1510, and 1512. Each RAW assignment field may include a RAW group field 1514, a RAW start time field 1516, a RAW duration field 1518, an options field 1520, the mode indication field 1522, a RAW slot definition field 1524, a channel indication field 1526, and an AP in doze state field 1528. If mode indication 1522 indicates a zero-th mode (which may for example be referred to as Mode 0), all STAs in the RAW group shall listen to the RA frame defined in the RAW-PS IE for their RAW group in the current Beacon interval. If mode indication 1522 indicates a first mode (which may for example be referred to as Mode 1), only STAs that have successfully send PS-Poll/trigger frames need to wake-up and listen to the RA frames defined in RAW-PS IE for their RAW group in the current Beacon interval).

When slot assignment is done in RPS-IE without using the RA-frame, the slots may be designed to be equal size, and allocation of STA to slot depends on the position of STA's AID bit in TIM. Multiple STAs may be assigned to the same slot, while at the same time some slots are empty. This may be due to the unpredictable wake-up behavior of power-saving STAs. A STA whose TIM bit is set may not necessarily wake up to poll the AP for downlink data. Therefore the slot assignment may take into account the unpredictable STA wakeup behavior, and some randomization method can be applied at each STA locally to improve the slot utilization.

According to various embodiments, random slot assignment indication may be added. The AP may allow the STAs to randomly choose a slot defined in RAW-PS IE. The slot assignment indication may be added in the slot definition field. For example when slot assignment indication indicates that random slot assignment is used, a STA may pick one random slot index in the range [Smin, Smax], where Smin corresponds to the index of the first slot for STA to choose, and Smax corresponds to the index of the last slot for STA to choose. The AP may broadcast the value of Smin and Smax in RAW-PS IE. Alternatively, a single default mode may be introduced. For example, when all slots can be chosen randomly by STAs locally (i.e. Smin=1 and Smax=total number of slots). The total number of slots can be calculated as:

Total number of slots=RAW duration/slot duration,

where the slot duration is defined in the slot definition field.

Upon reception of the indication that random slot assignment is enabled, each STA, subject to the RAW access restriction, may generate a random number in the range of [Smin, Smax]. A STA may access the channel no earlier than its allocated slot, whose index corresponds to the random number generated. STAs may also follow other restriction as indicated in the RAW option field.

Currently, the RAW group contains the range of AIDs whose corresponding STAs are eligible to use the RAW. STAs not in the RAW group are not eligible to use the RAW. STAs in the RAW group may also use the channel outside the RAW (e.g. OAW). It is necessary to constrain these STAs and prevent them from using the channel outside the RAW for fairness/protection of other STA's traffic/other purposes.

According to various embodiments, an access constraint indication may be added in RAW-PS IE. For example, a single access constraint bit may be used to indicate whether STAs in the RAW group are allowed to access the channel outside the RAW for the current Beacon interval. When the access constraint bit is set to 1, STAs in the RAW group shall not access the channel outside the RAW. When the access constraint bit is set to 0, STAs in the group may access the channel outside, the RAW. A STA in the RAW group needs to check the access constraint indication bit to determine whether it is allowed to use the channel outside the RAW defined by the RAW-PS IE.

In the following, enhancement to RAW slot assignment procedure according

to various embodiments will be described.

Since PAID (Partial Association Identifier) in SIG (SIGNAL) field is defined as 9 bits Partial AID value and is not needed for MU, according to Partial AID rules the following may be taken into account: (1) A STA that transmits a PPDU (physical protocol data unit) to an AP shall set the TXVECTOR parameter PARTIAL_AID to (dec(BSSID[39:47]) mod (2⁹−1))+1; (2) AP should not assign an AID to a STA that results in the PARTIAL_AID value, being equal to either (dec(BSSID[39:47]) mod (2⁹−1))+1 or (dec(Overlapping BSSID[39:47]) mod (2⁹−1))+1, we define the AIDs that can't be assigned due to the above reason as the void AIDs.

SIG may be the SIGNAL field of PPDU (physical protocol data unit). S1G PPDU (i.e. the PPDU format for 11ah) may include:
STF: Short Training field;
LTF: Long Training field;
SIG: SIGNAL field;
SIG-A: Signal A field;
D-STF: Short Training field for data;
D-LTF: Long Training field for data;
SIG-B: Signal B field; and
Data.

The Data field may carry the PSDU(s) (Physical layer Service Data Unit).

The null data packet (NDP) may include:
STF: Short Training field;
LTF: Long Training field; and
SIG: SIGNAL field.

In the following, it may be assumed that AP doesn't assign to the STA with the void AID.

If the void AID is allocated to a slot and not shared with any valid AID based on time slot allocation, the slot will be wasted. Thus, it may be desired to change the above implicit time slot allocation, taking into account the unassigned AIDs (void AIDs). The following exception case is only for the RAW group including the void AIDs.

AP may consider the setting of N_{RAW}, RAW duration and slot duration for the RAW group including the void AIDs.

The STA may keep track of the void AIDs. If it is in the same RAW group as the void AIDs, it may apply the following approach to avoid the slot allocation for the void AIDs.

In the following, it may be assumed that there are M void AIDs with the values denoted as y(i), where and the first and last AID in the RAW group are u and v respectively.

If the RAW is not restricted to STAs whose AID bits in the TIM element are set to 1, the total number of the AIDs that can be allocated to the slots is (v−u+1−M), but not (v−u+1).

The STA may compute its allocated slot using the following mapping function iₛₗₒₜ=(x+N_{offset}) mod N_{RAW} for u<=x<y(1), iₛₗₒₜ=(x−k+N_{offset}) mod N_{RAW} for y(k)<x<y(k+1), and iₛₗₒₜ=(x−M+N_{offset}) mod N_{RAW} for y(M)<x<=v, where x is the AID of the STA.

If there is no valid AID sharing with the same slot with AID=y(i), where i=1, . . . , M, the above slot allocation can be used.

If it is possible that there is at least one valid AID sharing with the same slot with AID=y(i), i=1, . . . , M, AP can change N_{RAW} to a proper value through setting RAW duration or slot duration to avoid the slot allocation to the void AIDs.

For example, if there are (v−u+1−M) AIDs including M void AIDs in the RAW group, we can set a N_{RAW} such that there is at least one valid AID (assume its AID value is z, not equal to y(i), where i=1, . . . , M) in the RAW group is assigned with the slot index which is the same as that for AID=y(i), i.e. (y(i)+N_{offset}) mod N_{RAW}=+N_{offset}) mod N_{RAW} for i=1, . . . , M.

Alternatively, if there is only one void AID y and y=v or y=u, one may set N_{RAW}(v−u) so that there is no slot allocated to the void AID.

However, it may be infeasible or not easy to tune N_{RAW}.

The method handling the void AIDs may be also used for MID (Multicast AID) assignment and slot allocation for MID traffic delivery when the implicit slot allocation is applied.

In the following, RAW operation indication will be described. This may be a basis for RAW operation as described herein.

The RAW-based channel access may support several modes of operations. In one mode of operation, the AP assigns STAs access slots implicitly via the RAW parameter set information element (RPS-IE) in the Beacon. The RPS-IE format is shown and described above with reference to Table 1.

In another mode of operation, the AP schedules STA in a RAW for data delivery by transmitting a management frame, say, the Resource Allocation (RA) frame. Prior to the RA frame transmission, STAs may contend for channel to transmit PS-Poll/trigger frames to AP to request for downlink buffered data and/or indicate uplink data. There may be different uplink and downlink frame format or unified RA frame format for UL (uplink) & (and) DL (downlink). The RA frame may include the information such as AID group in the RAW, RAW duration, traffic indication, and time slot assignment (e.g. starting time and duration or number of slots) for each STA with AID in the group. Table 2 illustrates the core information that may be conveyed by the RA frame. The RA frame may also contain slot assignment for group addressed frames.

TABLE 2
Scheduling information conveyed in the RA frame

| AID | Direction control | Schedule |
|---|---|---|
| (full/partial) | (uplink/downlink/TBD) | (offset in TU from RA frame) |
| AID 1 | Downlink | t_1 |
| . . . | | |
| AID n | Downlink then uplink | t_n |

In another mode of operation (two-RAW operation), the AP assigns a first RAW (RAW1) for STAs to transmit poll/trigger frames. Following that, AP transmits a RA frame and schedules the data delivery in the second RAW (RAW2).

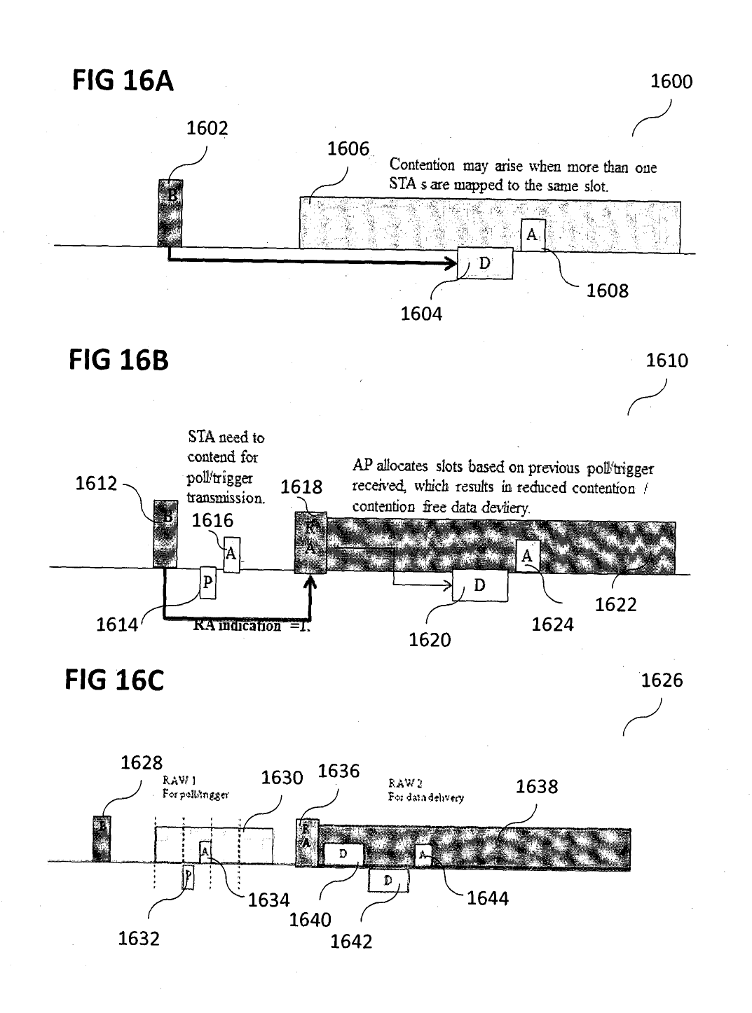

Examples of the above operating modes are shown in FIG. 16A, FIG. 16B, and FIG. 16C.

FIG. 16A, FIG. 16B, and FIG. 16C show illustrations of RAW operating modes, in which B indicates a beacon, D indicates Data, A indicates an ACK, and P indicates a poll (in other words: a trigger). Information sent by AP may be indicated above the horizontal line, and information sent by STA may be indicated below the horizontal line.

FIG. 16A shows an illustration 1600 of a RPS-IE based implicit scheduling. The AP may send a beacon 1602. The STA may send data in 1604, which may be acknowledged by AP in 1608. Contention may arise in 1606 when more than one STA are mapped to the same slot. The STA may also transmit a poll/trigger frame in its allocated RAW slot before data delivery.

FIG. 16B shows an illustration 1610 of a of RA-based explicit scheduling. The AP may send a beacon 1612, in which RA indication may be 1, like indicated by the arrow from 1612 to 1618. The STA may send a poll 1614, which may be acknowledged by the AP in 1616. The STA need to contend for poll/trigger transmission. In 1618, the AP may transmit an RA frame, and may allocate slots based on previous poll/trigger received, which may result in reduced contention or contention free data delivery during 1622. In 1620, the STA may transmit data to the AP, which may be acknowledged in 1624.

FIG. 16C shows an illustration 1626 of a two-RAW operation. The AP may transmit a beacon 1627. RAW1 may only be for poll/trigger based on RPS-IE (for example transmitted in the beacon 1626). Box 1630 may indicate the RAW 1. The STA may transmit a poll 1632, which may be acknowledged in 1634. The AP may transmit a RA frame 1636. RAW2 may be for data delivery based on the RA frame 1634. The AP may transmit data 1640, and the STA may transmit data 1642, which may be acknowledged in 1644. Box 1636 may indicate the RAW 2.

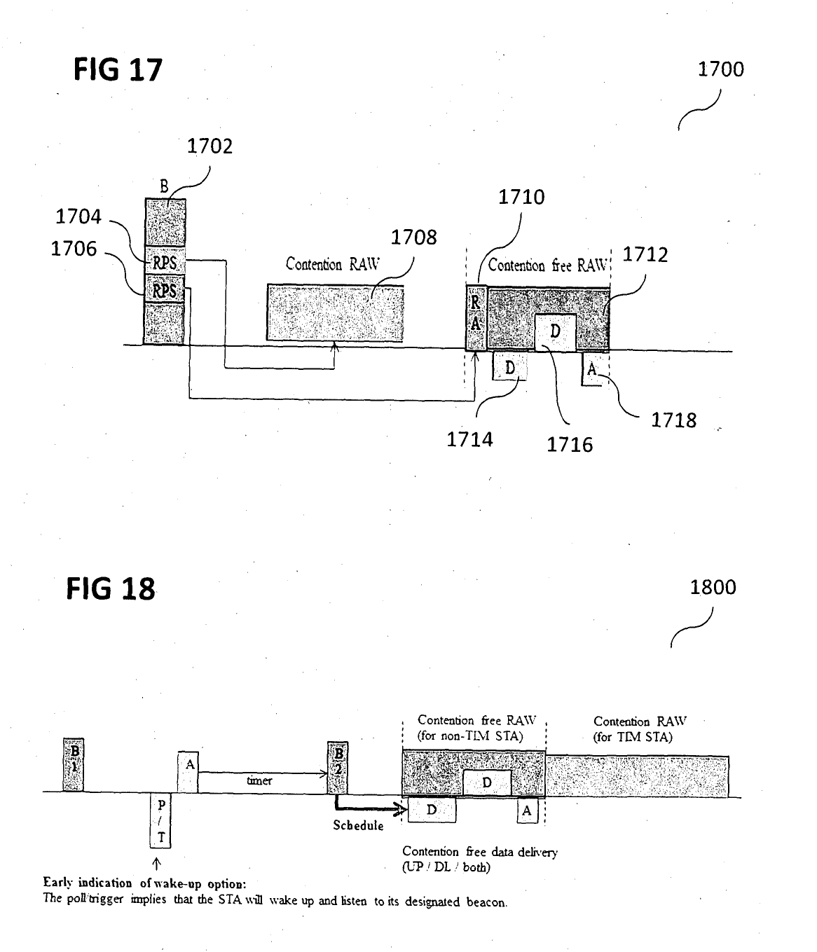

Based on the current specification, when there are multi-RAW operations such as described with reference to FIG. 16C, multiple RPS-IEs are needed as shown in FIG. 17.

FIG. 17 shows an illustration 1700 of a use of multiple RPS-IEs to support multi-RAW operation, in which B may indicate a beacon, D may indicate data, A may indicate an ACK, and P may indicate a poll/trigger. The AP may transmit a beacon 1702, which may include a plurality of RPS, for example a first RPS 1704 and a second RPS 1706. The first RAW 1708 may be for poll/trigger frames. The second RAW 1712 may be for data delivery. The AP may send a RA frame 1710. The STA may send data 1714. The AP may send data 1716, which may be acknowledged in 1718.

Each RPS-IE may indicate the parameters for a corresponding RAW. Using multiple RPS-IEs may create large overhead and may overload the Beacon. More efficient support of multi-RAW operation may be provided according to various embodiments.

According to various embodiments, the RAW operation mode and associated RAW operation parameters may be indicated in the Beacon to the STA. The benefit of indicating the RAW operation mode and parameters in the Beacon may be that a STA can derive the open access window (OAW) from the Beacon. OAW is the time in a Beacon interval excluding the RAW.

The AP may use reserved/used bits to indicate RAW operation mode. For example, the Access Right bits may be used to indicate the two-RAW operation as shown in Table 3.

TABLE 3
An example of using the Access Right
bits to indicate two-RAW operation.
Fields similar to Table 1 are not shown.

| | | | |
|---|---|---|---|
| Access Right | 2 | B1 | B2 |
| | bits | 0 | 0: any STA |
| | | 0 | 1: RAW1 (poll/trigger) followed by |
| | | | RAW2 (data) |
| | | 1 | 0: paged STA UL |
| | | 1 | 1: short frames like PS-Poll |

| | | |
|---|---|---|
| Group/Resource | 1 | Set to 1 to indicate if STAs need to wake up |
| allocation frame | bit | at the beginning of the RAW to receive group |
| indication | | addressed frames such as resource allocation |
| | | (format of the resource allocation frame TBD) |
| Slot definition | TBD | Include |
| (for RAW 1) | bits | Slot duration signaling |
| | | Slot assignment to STA |
| | | Cross boundary transmissions allowed/not |
| | | allowed |
| | | Format is TBD |
| RAW2 | TBD | Subfield to indicate RAW2 parameters if: |
| parameters | | Access Right = 01: |
| (present if Access | | Start time offset |
| Right = 01) | | Duration |

Currently, the two Access Right bits have only three definitions. By using the remaining one definition (e.g. Access Right=01 in this example), the AP may indicate that it is operating two RAWs as shown in FIG. 16C. The AP also may add another field to indicate RAW2 parameters such as the starting time offset and the duration if Access Right=01.

The AP may use a combination of several sub-fields to indicate RAW operation mode. In an example shown in Table 4, when the Access Right is set to 01, it indicates that a STA needs to decode the Group/RA frame indication bit to know the operating mode. The Access Right field may be used together with another field (e.g. Group/RA indication) to support the multiple operating modes. In this example, when the Group/RA indication is 1, the operating mode is two-RAW. The Group/RA indication of 0 indicates some other operating mode to be determined (TBD).

TABLE 4
An example of using multiple sub-fields
to indicate RAW operation modes.
Fields similar to Table 1 are not shown.

| Access Right | 2 bits | B1 | B2 |
|---|---|---|---|
| | | 0 | 0: any STA |
| | | 0 | 1: Operating mode |
| | | 1 | 0: paged STA UL |
| | | 1 | 1: short frames like PS-Poll |

| | | |
|---|---|---|
| Group/Resource | 1 bit | 1: Two-RAW |
| allocation frame | | 0: TBD |
| indication | | |
| Slot definition | TBD | Include |
| | bits | Slot duration signaling |
| | | Slot assignment to STA |
| | | Cross boundary transmissions |
| | | allowed/not allowed |
| | | Format is TBD |
| RAW2 parameters | TBD | Subfield to indicate RAW2 parameters if: |
| (present if Access | | Access Right = 01; AND |
| Right = 01 AND | | Group/RA frame indication = 1. |
| Group/RA indication = | | Start time offset |
| 1) | | Duration |

In another example as shown in Table 5, the AP may use the Access Right=01 as extended operation indication. If Access Right=01, extended operation modes such as two-RAW operation is supported. Otherwise, the same RPS-IE frame format shown in Table 1 is used. In extended operation mode (Access Right=01), the RAW operation mode (e.g. two-RAW) is indicated by AP and corresponding parameters (e.g. RAW2 starting time and duration) are also specified.

TABLE 5
Another example of using multiple sub-
fields to indicate RAW operation modes.
Fields similar to Table 1 are not shown.

| Access Right | 2 bits | B1 | B2 |
|---|---|---|---|
| | | 0 | 0: any STA |
| | | 0 | 1: Extended RAW operation indication |
| | | 1 | 0: paged STA UL |
| | | 1 | 1: short frames like PS-Poll |

| | | |
|---|---|---|
| Group/Resource | 1 bit | Set to 1 to indicate if STAs need to wake up at |
| allocation frame | | the beginning of the RAW to receive group |
| indication | | addressed frames such as resource allocation |
| | | (format of the resource allocation frame TBD) |
| RAW operation | 2 bits | If Access Right = 01: RAW operation |
| indication | | indication |
| (present if Access | | 00: Two-RAW operation |
| Right = 01) | | 01: TBD mode |
| | | 10: TBD mode |
| | | 11: TBD mode |
| | | Else: slot definition |
| RAW parameters | TBD | Present only if Access Right = 01. |
| (present if Access | | The field indicates RAW1 and possibly |
| Right = 01) | | RAW2 operating parameters. |

The AP may add some bits in RPS-IE to explicitly indicate RAW operation mode, and subsequent field definitions depend on the operation mode. An example is shown in Table 6. The bits used for RAW operating mode indication may come from reserved bits. Alternatively, AP may add a new IE to indicate the RAW operating mode and the new IE can be used jointly with the RPS-IE.

TABLE 6
Example of explicit RAW operating mode indication. The
relative location of the fields can be changed. Support
for the first three RAW operating modes should be mandatory,
and other operating modes may also be supported.

| Feature | Value | Interpretation |
|---|---|---|
| Page ID | TBD bits | Indicates the page index for hierarchical |
| | | AID (based on hierarchical AID) of the |
| | | allocated group |
| Block | TBD bits | Assuming 32 blocks per page, these bits |
| Offset | | indicate the starting block index of the |
| | | allocated group |
| Block | TBD bits | Indicates the number of blocks (starting |
| Range | | from the block offset) for the allocated group |
| RAW | 2 bits | 00: implicit scheduling based on RPS-IE |
| operating | | 01: explicit scheduling using RA |
| mode | | 10: two-RAW operating |
| | | 11: TBD |
| | | (more bits are needed to support more |
| | | operating modes) |
| RAW | TBD bits | RAW operating parameters based on RAW |
| operating | | operating modes: |
| parameters | | 00: RAW start time, RAW duration, Access |
| | | Right, Group frame indication, and slot |
| | | definition. |
| | | 01: RAW start time, RAW duration, Access |
| | | Right, Group frame indication. |
| | | 10: RAW start time, RAW duration, Access |
| | | Right, Group frame indication, slot definition |
| | | for RAW1, and RAW2 parameters |
| | | 11: TBD |

One advantage of operating mode indication is that some fields in the RPS-IE may be eliminated to reduce Beacon overhead. E.g. if RA-based RAW is used, the slot definition field may not be necessary, as slot assignment may be carried in the RA frame. Another advantage is more flexible support for multiple modes of operation such as data delivery based on single RAW or multiple RAWs.

In addition to IE-based method, an alternative to support multi-RAW operation may be via the AP's response frame. The RPS-IE in beacon may point a STA to its allocated slot for poll/trigger frame transmission. After receiving the poll/trigger frame from a STA, AP may respond with a timer pointing to the targeted RA frame transmission time. The STA may listen to the RA frame, which may include the schedule for data delivery.

In the following, support for non-TIM STAs will be described.

A STA may choose not to have a TIM entry and does not need to listen to the Beacon. Such STAs usually operate in low power mode. They may send a poll/trigger frame any time to query AP for buffered downlink data. AP may defer the data delivery to such non-TIM STA.

In one case, AP may respond with a timer pointing to a Beacon that carries the non-TIM STA's downlink data buffer status. Instructing a STA to listen to Beacon serves two main purposes: one is to indicate via TIM the downlink buffer status for the STA, and the other is to schedule data delivery between the AP and the STA (if there is any buffered uplink or downlink data), possibly with reduced contention. When there is no downlink data buffered at the AP and the STA indicates there is no uplink data, AP may respond to the poll/trigger with an ACK with MoreData bit set to zero. The STA may then doze. In other cases, AP may respond with a timer pointing to Beacon, and the non-TIM STA temporarily switches to TIM mode. The Beacon may contain information such as RAW parameter for data delivery between the AP and the STA with reduced contention. AP may indicate in the Beacon whether non-TIM/low-power mode STAs need to re-send poll/trigger frame after they have resynchronized through the timer indication in AP's response frame to its unscheduled poll/trigger frame. AP and STA may negotiate through association procedure or other management frame exchange on this feature. By default, non-TIM STA that has received the response with timer needs not transmit poll/trigger again, as AP can assume that the STA will wake up to receive Beacon. The data delivery/exchange occurs as scheduled in the Beacon. The contention involved in the data delivery/exchange may be reduced or even eliminated. This can be achieved by RPS-IE or RA based RAW as described earlier.

The AP may point a STA to a Beacon and schedule via, the Beacon a contention-free or reduced-contention period for data delivery between AP and STA. The STA, having received the response with timer, earlier, may not transmit another poll/trigger again by default or through an indication in the Beacon. The STA may doze if no resource is scheduled to it by AP via the Beacon. This is illustrated in FIG. 18.

FIG. 18 shows an illustration 1800 of scheduling of non-TIM STA to contention-free RAW/reduced contention RAW via Beacon. Either AP or STA may initiate the delivery. The direction of data delivery may be indicated by AP in Beacon/poll response, or based on predefined rules.

The scheduling information may be carried by a new IE in Beacon that has similar format as the RA frame either in the current Beacon interval or in any of the following Beacon intervals. It should be able to indicate at least the start of the RAW, the AID of scheduled STAs (either explicitly or using a bitmap), and the channel access time assigned to the corresponding STAs. The scheduling information can also be carried in the RPS-IE, and used together with the RAW operating mode indication bits, which indicate a contention free RAW for data delivery to non-TIM STAs that have sent poll/trigger earlier.

In another case, AP may respond with a timer pointing to a management frame such as the RA frame. AP and STA may negotiate this feature during association or through management frame exchange. The STA may not check the Beacon for buffered data status. It may not transmit poll/trigger again upon timer expiration either, as AP can assume that the STA will wake up to receive the management frame. If the RA frame allocates channel resource to the STA, the STA may use the allocated resource for data exchange. If no channel resource is allocated to the STA by the management frame, the STA may doze. The management frame may contain scheduling information dedicated to non-TIM STAs only, or mixed with TIM STA.

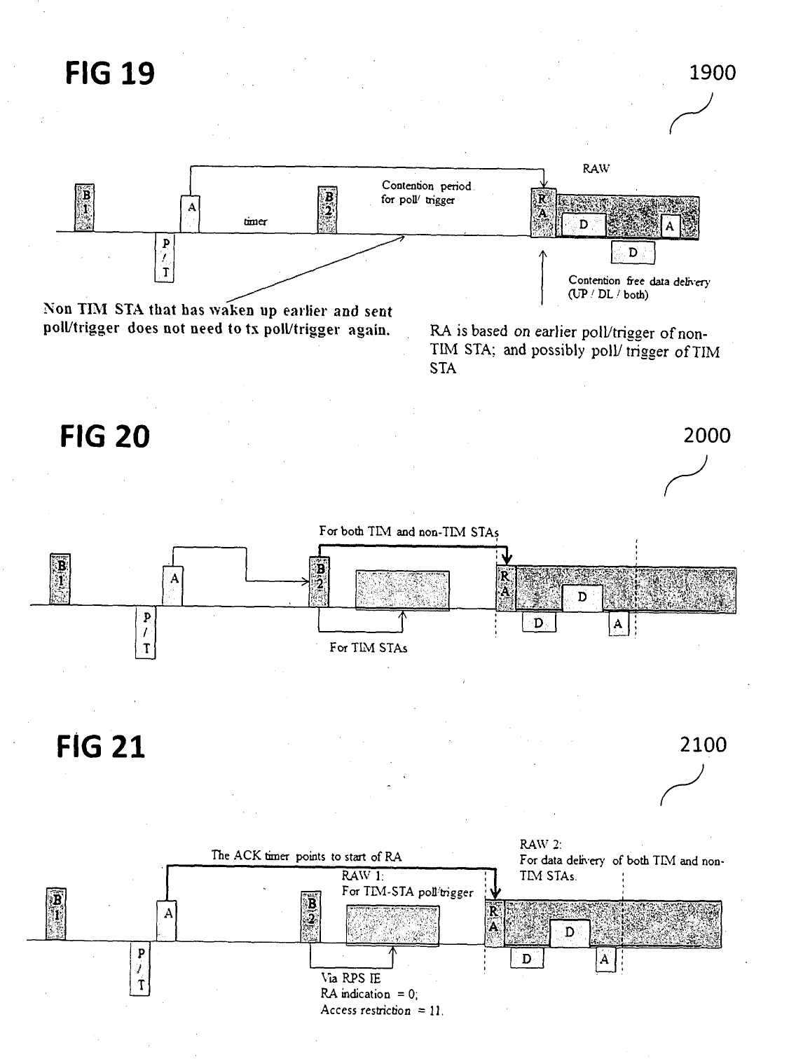

The AP may point a STA to a management frame (e.g. Beacon/RA frame) and schedule via the management frame (e.g. Beacon/RA frame) a contention-free or reduced-contention period for data delivery between the AP and STA. The STA that has received the response with timer earlier may not transmit another poll/trigger again by default or through an indication in RA frame. The STA may doze if no resource is scheduled to it by AP in the management frame. AP and STA may negotiate this feature during association or through management frame exchange. This is illustrated in FIG. 19.

FIG. 19 shows an illustration 1900 of scheduling of non-TIM STA based on RA frame. The AP may use the timer to point the STA to the RA frame directly.

FIG. 20 shows an illustration 2000 of scheduling of non-TIM STA via Beacon for two-RAW operation.

When the AP adopts two-RAW operation, the non-TIM STA can be supported as shown in the subsequent figures. In FIG. 20, the non-TIM STAs may be pointed to a following Beacon after their poll/trigger frame. The Beacon contains the two-RAW operation parameters, and non-TIM STAs can read the RA frame start time from Beacon together with TIM STAs. AP may indicate via Beacon whether a non-TIM STA needs to listen to the RA frame and whether it needs to resend poll/trigger frame.

FIG. 21 shows an illustration 2100 of scheduling of non-TIM STA via RA frame directly in two-RAW operation. In the example shown in FIG. 21, the non-TIM STAs may be pointed to the RA frame directly by AP's response timer. They need not listen to the Beacon, as the status of their downlink buffered data can be inferred from whether the non-TIM STAs may be scheduled any resources in the RA frame.

In the following, RAW protection will be described.

Some STAs (e.g. non-TIM STA) may not know the RAW parameters within the current Beacon interval and their transmission may collide with/encroach the RAW. AP may protect the subsequent RAW and prevent the STAs, and possibly other third-party STAs from accessing the RAW.

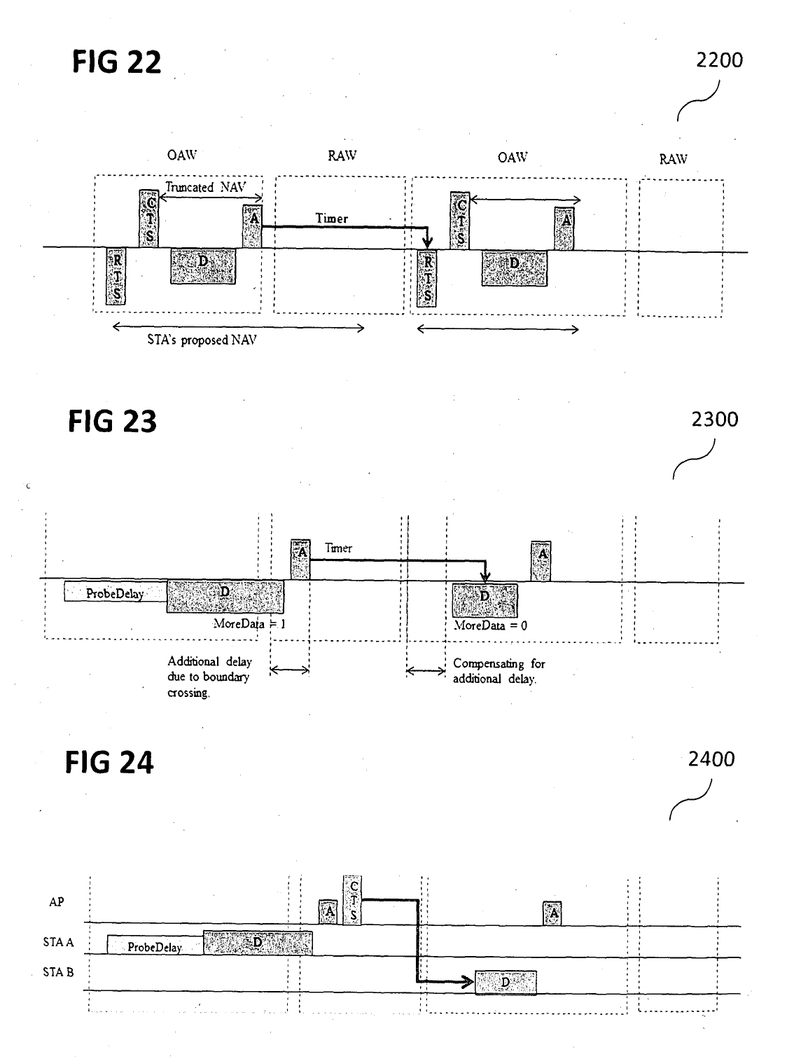

The AP may use a response timer to defer the STA's channel access (e.g. to an OAW). The response timer can also serve as an ACK indication. Upon expiration of the timer, the STA may begin the uplink transmission via contention. An example is shown in FIG. 22, where the AP uses a response timer to defer a STA's channel access to the next OAW to protect the RAW. AP may know the STA has more uplink data based on the MoreData bit in the first Data frame.

FIG. 22 shows an illustration 2200 of RAW protection based on response timer. STA uses RTS to initiate uplink transmission.

The AP may also use a CTS to truncate a STA's TXOP request. When the AP uses the first CTS to truncate the NAV in first OAW, it infers that the STA will attempt to transmit the remaining uplink frames later. The STA may also set the MoreData bit to 1 to indicate it has more uplink data following. In the second OAW, the STA transmit RTS again upon timer expiration.

The STA may also transmit uplink data directly to AP, as shown in FIG. 23.

FIG. 23 shows an illustration 2300 of RAW protection based on response timer. STA transmits uplink data directly without RTS.

The AP may choose to respond with a timer regardless the uplink data buffer status of the current STA. In this way, third-party STAs may make use of the timer to find the next OAW. STAs that have been scheduled to RAW may neglect the timer.

Instead of using a response timer, the AP may use a frame (e.g. CTS, NDP-CTS or similar) to explicitly set the NAV for STAs, that do not have the Access Right in current RAW. For STAs that have the Access Right in current RAW (i.e. STAs that have been allocated slots implicitly or explicitly in the RAW), they may neglect the NAV setting. This is illustrated in FIG. 24.

FIG. 24 shows an illustration 2400 of the AP using a broadcast CTS to defer STA's channel access.

When the STA's transmission in first OAW encroaches the RAW, AP will transmit a broadcast CTS (e.g. in SIFS (Short Interframe Space) time after ACK to STA A) to protect the current RAW and defer non-scheduled STAs from using the channel by setting their NAV (Network Allocation Vector) specified in the broadcast CTS Duration. Non-scheduled STAs can only contend for the channel after the NAV timer expires. Scheduled STAs can neglect the NAV setting. Instead of waiting for some IFS before transmission the CTS, AP may also respond with a new single frame type (e.g. CTS+ACK) containing the ACK addressed to previous data transmission and the timer to defer all third-party STA's channel access to protect RAW.

A STA may transmit a short frame like RTS/Poll/Trigger to initiate uplink data transmission, or it can transmit the uplink data directly. In a central-controlled network, the AP may determine the initial uplink frame transmission.

The AP may indicate RAW Protection Enable/Disable in an information element that is broadcasted in Beacon or transmitted in Probe Response or (Re)association Response. When the RAW protection subfield indicates that the RAW protection is enabled, STAs are required to transmit some control signal (e.g. RTS) first before uplink data transmission. For STAs that have the access right in current RAW (i.e. STAs that have been allocated slots implicitly or explicitly in the RAW), they may neglect the rule and can transmit intended uplink frames directly.

When the data transmission is finished earlier than the end of current RAW, AP may transmit a short frame (e.g. CF-end) to indicate the termination of current RAW, and the channel time may be used for open access.

It may be known that in the IEEE 802.11ah standard, the AP may declare a Restricted Access Window (RAW). STAs associated to the same AP but not in the list for RAW access shall not access the channel until the current RAW ends. However, for those low power STAs, they may wake up after the RAW is started. After listening to the channel for a while, for example, receiving either a data or ACK packet, it is allowed to access channel. The channel access activity from these low power stations may prevent those STAs in the RAW list from transmitting data packets as scheduled. In such situation, the use of RAW becomes not that efficient as expected.

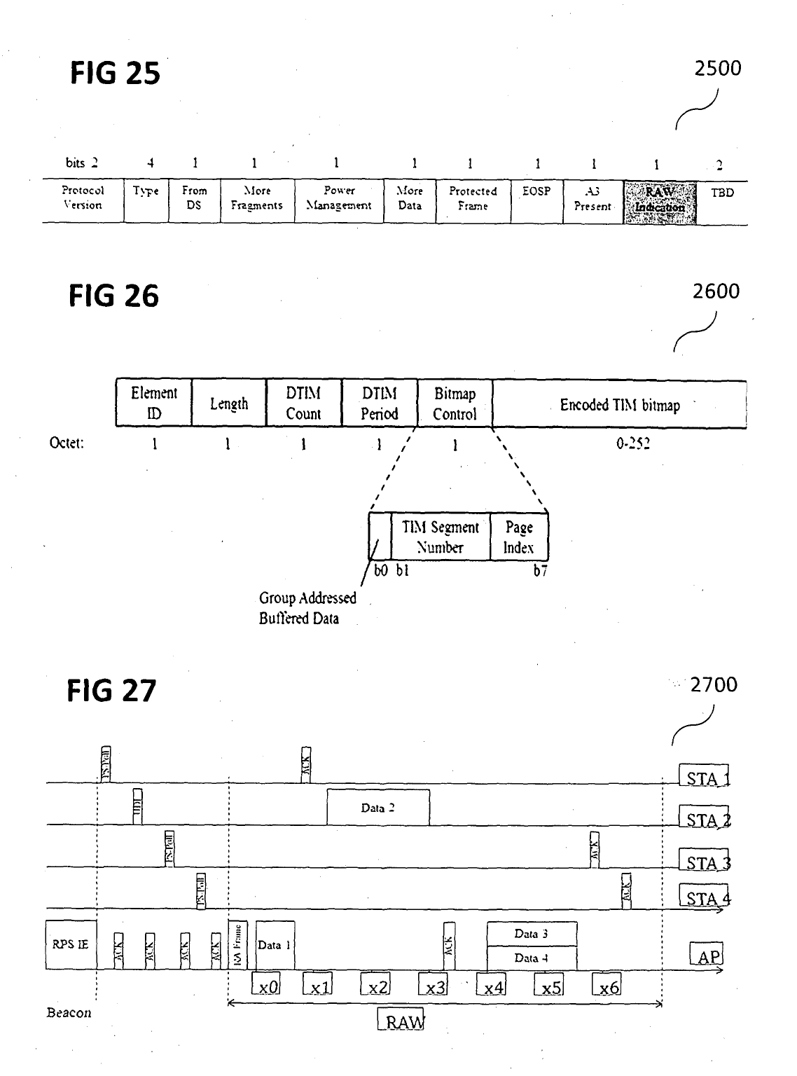

To avoid those low power stations from distracting the scheduled channel access by RAW, one bit may be reserved either in the Frame Control field as shown in FIG. 25 or in the SIG field to indicate that the current channel access falls in a RAW or not. A possible embodiment is that when the desired RAW indication bit is set to 1, it indicates that the current channel access is in RAW and those stations that are not included in the list for RAW access shall not access the channel. If RAW indication bit is set to zero, then it indicates the current channel access is not in a RAW and stations are allowed to access the channel as usual.

FIG. 25 shows an illustration 2500 of indicating RAW with a bit in frame control field.

Other RAW indication methods may include that in the ACK, including the short ACK, the duration field in the ACK may be set to point to the end of current RAW. Traditionally, the duration field of ACK is set to zero if there are no data frame following the current ACK and is set to non-zero to protect the following data frames from the station who is supposed to receive the ACK. AP and station may use this feature to protect the RAW as follows: for AP and stations in the RAW, when they transmit ACK, they may set the duration field of the ACK and let it point to the end of the RAW. For station in the RAW access list, they access the channel as scheduled and may not be limited by the duration field setting in ACK. But for those stations not included in the RAW access list, they may not be allowed to access the channel within the period specified by the ACK. They may update their NAV based on the duration field in the ACK.

In the following, AP's response timer enhancement will be described.

There may be several cases where AP can respond to a STA with a timer/timer indication. The subsequent action after the timer expiration is also different. Some of these cases are described in the following.

In one case, in response to a STA's uplink frame (which could be a poll/trigger frame, RTS, or data frame), AP uses the timer to defer the STA's channel access. Upon expiration of the timer, the STA is allowed to contend for the channel again. This scheme may be used for RAW protection. In another case, in response to a STA's uplink frame (which could be a poll/trigger, RTC, or data frame), AP uses the timer to indicate to STA that AP will only transmit downlink frame (e.g. data/management frames/control) to the STA after the timer expires. The STA may doze for some time and wake up upon expiration of the timer to receive downlink frames (which could be data, management, or control frame) from AP. In such cases above, the STA may be required to transmit again or listen to some frames. It is necessary to indicate to STA the possible action upon expiration of the timer.

The AP may indicate explicitly the expected action upon timer expiration such as transmit uplink data frame, re-transmit uplink request (e.g. management/control frames), receive management frame (e.g. Beacon, resource allocation, action frames), receive control frame (e.g. CTS), and receive downlink data. The response type indication can be based on the polling response frame that carries the deferred channel access time/duration. Some additional bits are added to indicate the expected action after the timer expires. For example, when 2 bits are used for expected action indication, the expected actions may include: (00) receive management/control frame; (01) receive data frame; (10) transmit uplink poll/trigger; and (11) transmit uplink data. The above actions are mapped to the four values represented by the 2-bit response type indication. AP may also use, for example, two more bits to indicate whether the timer is intended for: (00) the receiving STA; (01) all the STA, (10) the scheduled STA; and (11) the non-scheduled STA. Alternatively, one single bit can be used to indicate whether the timer is intended for the receiving STA only or the broadcasted to all STAs (although the specification rule may allow that scheduled STA to neglect the timer). The values of ExpectedAction and IntendedSTA subfields and their corresponding interpretation are summarized in Table 7. It will be understood that Table 7 may only be for illustration, and the actual mapping may be like shown in Table 7 or may be different. More bits values will also support more operating modes.

TABLE 7
Summary of definitions for ExpectedAction and IntendedSTA.

| | Indicates expected | | |
|---|---|---|---|
| Expected | action upon timer | Intended | Indicates eligible STA to |
| Action | expiration. | STA | use the timer |
| 00 | receive management | 00 | receiving STA only |
| | frame (e.g. RA, | | |
| | Beacon) | | |
| 01 | receive data frame | 01 | all the STA |
| 10 | transmit uplink | 10 | scheduled STA |
| | poll/trigger | | |
| 11 | transmit uplink data | 11 | non-scheduled STA |

In one example, AP may use the response timer to defer a STA's uplink transmission for RAW protection. AP may request the STA to transmit RTS by specifying the ExpectedAction=10, or AP can specify the ExpectedAction=11 to indicate to STA it may transmit uplink data directly without RTS. AP may specify that the timer can be used by all non-scheduled STA by specifying the IntendedSTA=11 as described above.

In another example, AP may use the response timer to point a STA to a reduced contention RAW for data transmission as described above. In this case, AP can specify the timer is intended to the receiving STA only by setting IntendedSTA=00. AP may allow the STA to transmit uplink data first by setting ExpectedAction=11, or AP can transmit the downlink data first by specifying the ExpectedAction=01.

In another example, AP may use response timer to indicate RA frame start time in two-RAW operation as described above. In this case, AP sets the ExpectedAction=00 and IntendedSTA=00. Similarly AP may use the response timer to indicate the expected Beacon transmission time by setting ExpectedAction=00.

In the following, group addressed traffic delivery will be described.

In current specification framework document (r11) for IEEE $02.11 ah, the Group Addressed Buffered Data field (Bit 0 of the Bitmap Control field) may be set to 1 when one or more group addressed MSDUs (MAC service data unit)/MMPDUs (MAC Management Protocol Data Unit) are buffered at the AP.

FIG. 26 shows an illustration 2600 of Group Address Buffered Data Bit Indication in Bitmap Control Field of TIM IE.

When DTIM beacon frame sets Group Addressed Buffered Data field as one, it indicates that there will be group addressed traffic broadcast to the STAs. Although the group addressed buffered data can be sent immediately after the beacon, non-TIM STAs in the same BSS (Basic Service Set) or the STAs in other BSS may contend the channel such that the broadcast traffic can't be transmitted after some interval e.g. before the start of first RAW.

If group addressed traffic is not able to finish before the start of the RAW and is not allowed to use RAW to complete, it could be deferred to the end of the RAW (which is Open Access Windows). However, further indication is required for the STAs to know when is the next transmission time for the group addressed traffic, which makes this method more complicated. If the transmission time of group addressed traffic is immediately after the RAW in the same beacon interval, the STAs should wakeup to receive the pending unfinished group addressed traffic.

As RAW has specified the starting time in RAW Parameter Set IE, the STAs that are in the group indicated by RAW PS IE have to give up their assigned slots when the transmission of group address traffic encroaches into the time slots in the RAW. If there are remaining slots that are not assigned, these STAs can make use of them. AP may allocate and reserve some time slots for this case. However, RAW usually doesn't have any unallocated slots. To avoid the case of the time slots encroached by group addressed traffic delivery, AP can either set a TXOP (reserve some channel access time) or reserve some slots in the RAW for the transmission of group addressed traffic.

To avoid the contention from other STAs, AP can send a protection indication before the transmission of group addressed traffic. The indication may be sent before the beacon transmission, in the beacon, or immediately after the beacon (e.g. SIFS time after the end of the beacon). The indication could be sent through e.g. CTS-to-itself, including the protection time for channel access. If the group addressed traffic is sent after DIFS and some backoff time at the end of the beacon, other transmissions may cause the contention to the transmission of group addressed traffic. Since RAW PS IE includes Group/Resource allocation frame indication (as shown in FIG. 26), which is set to 1 to indicate if STAs need to wake up at the beginning of the RAW to receive group addressed frames such as resource allocation (format of the resource allocation frame TBD), slot assignment and resource allocation based on TIM-RAW access need to consider the group addressed traffic.

In the following, slot assignment for group addressed traffic will be described.

The slot assignment for group addressed traffic may be included in RAW PS IE and Resource Allocation frame. When there is no Group Addressed Buffered Data field is set to 0, no change is required with regarding to slot assignment for this data delivery.

One of the slot assignment schemes for TIM-RAW based channel access could be simply just spread the STAs into the time slots based on AID position in the bitmap for traffic indication. We can include the information of the number of slots that are assigned to group addressed frames and its starting slot index, e.g. into RPS-IE.

A value of N_{R} which indicates the number of slots that are assigned may be included to group addressed traffic.
N_{R} may be explicitly indicated in the beacon (e.g. RPS-IE or Resource Allocation IE) or implicitly indicated in other frames (e.g. association);
If N_{R} is fixed as 1, it can be known to STA by default.

To simplify the slot assignment function, the starting slot index for group addressed frame may be the first slot or last slot. When AP spreads the STAs into the time slots, it should not mix the slot(s) reserved for group addressed frame(s) with the slots for the STA's unicast traffic frame.

In the following, a resource allocation frame format will be described.

One of the resource allocation frame formats for TIM-RAW based channel access may include the time slot starting time and duration. Starting time or equivalently an offset to the beacon timestamp or RA frame starting time for Group Addressed Frames may be included in Resource Allocation IE/frame, e.g. 1^{st} at place at slot assignment if there is Group Addressed Frames. When the AP allocates the time slots to the STAs, it should not mix the slot(s) reserved for group addressed frame(s) with the slots for the STA's unicast traffic frame.

In the following, group addressed traffic delivery to non-TIM STAs will be described.

The DTIM Period field may indicate the number of beacon intervals between successive DTIMs. If all TIMs are DTIMs, the DTIM Period field has the value 1. The DTIM Period value 0 is reserved. The DTIM period field is a single octet.

Since non-TIM STA is not required to listen to the beacon, if it wants to receive the group addressed traffic indicated in the DTIM beacon (e.g. ReceiveDTIMs=TRUE), non-TIM STA can send PS-Poll/trigger frame or other frame with the request indication for group addressed traffic and expect to be replied with a response frame with a time/timer indication upon it sends out unscheduled polling/trigger frame.

If all STAs are in non-TIM mode, AP is not required to send group addressed frames (including buffered data) unless PS-Poll/trigger frame sent by non-TIM/low power STA includes the request indication for group addressed traffic (define a ReceiveDTIMs bit in PS-Poll/trigger frame and (NDP) PS-Poll/trigger frame) so that AP can prepare group addressed traffic for the STA.

The response frame may include a timer/time indication to help the non-TIM STA re-synchronizing with DTIM beacon. The time/timer indication could point to TIM beacon or DTIM beacon. Since the TIM IE includes DTIM period and DTIM count, non-TIM STA can receive unicast traffic in TIM beacon interval and then sleep until the target DTIM beacon. AP should set the group addressed traffic bit on in Bitmap Control field of TIM IE in DTIM beacon if there is buffered group addressed traffic: After waking up to receive DTIM beacon, non-TIM STA will determine whether to receive group addressed traffic.

If there are TIM and non-TIM mode STAs, the AP may send group addressed traffic after DTIM beacon. Non-TIM STAs may have to re-synch with DTIM beacon before receiving group addressed, traffic. Multipage TIM/non-TIM STAs may have to receive DTIM beacon before receiving group addressed traffic.

In the following, the indication of ReceiveDTIMs will be described.

When true, this parameter may cause the STA to awaken to receive all DTIM frames. When false, the STA is not required to awaken for every DTIM frame.

With explicit slot allocation for group addressed traffic, the STAs may be able to go to sleep (choose not to receive group addressed traffic) for that assigned slot(s), but the STAs should listen to resource allocation if they want to access the channel.

In the following, RAW operating mode indication according to various embodiments will be described.

Conventional channel access methods based on CSMA/CA is optimum only for a small number of contending STAs. However, in some of the IEEE 802.11ah use cases, it is expected that the contention domain is formed by a large number of client STAs, and such contention overhead is inefficient in terms of both channel usage and power consumption. Therefore several channel access mechanisms have been provided for IEEE 802.11ah to support more efficient channel usage at low power. For example, the concept of Restricted Access Window (RAW) may be provided to spread the STAs' channel access into multiple slots to reduce contention and achieve power saving. In the following, enhancement for RAW-based channel access in IEEE 802.11ah according to various embodiments will be described.

The RAW-based channel access may support several modes of operations. In one mode of operation, the AP assigns STAs access slots implicitly via the RAW parameter set information element (RPS-IE) in the Beacon. In another mode of operation, the AP schedules STA in a RAW for data delivery by transmitting a management frame, say, the Resource Allocation (RA) frame. Prior to the RA frame transmission, STAs may contend for channel to transmit PS-Poll/trigger frames to AP to request for downlink buffered data and/or indicate uplink data. There may be different uplink and downlink frame format or unified RA frame format for UL & DL. The RA frame includes the information such as AID group in the RAW, RAW duration, traffic indication, and time slot assignment (e.g. starting time and duration or number of slots) for each STA with AID in the group. In other modes of operation (multi-RAW operation), the AP may assign the first RAW (RAW1) for STAs to transmit poll/trigger frames. The subsequent RAWs are then used for data delivery. For example, AP may transmit a RA frame and schedules the data delivery in the second RAW (RAW2).

Based on the current specification, when there are multi-RAW operations, multiple RPS-IEs are needed. Each RPS-IE indicates the parameters for a corresponding RAW. Using multiple RPS-IEs creates large overhead and may overload the Beacon. More efficient support of multi-RAW operation is described in the sequel. According to various embodiments, device and methods may indicate the RAW operating mode and associated RAW operating parameters in the Beacon to the STA. The benefit of indicating the RAW operating mode and parameters in the Beacon is that a STA can derive the open access window (OAW) from the Beacon. OAW is the time in a Beacon interval excluding the RAW.

The AP may add some bits in RPS-IE to explicitly indicate RAW operating mode, and subsequent field definitions may depend on the operating mode. An example is shown in Table 8. The bits used for RAW operating mode indication may come from reserved bits. The number of bits used for RAW operating mode indication is for illustration. More operating modes can be supported explicitly by using more number of bits. In general, M bits can be mapped uniquely to 2̂M operating modes.

TABLE 8
An example of explicit RAW operating mode indication for
up to N RAWs. The relative location of the fields can
be changed. Reserved fields are omitted. When the RAW
operating mode is 00/01 that indicates single RAW operation,
only RAW 1 operating parameter subfield is present.

| | Feature | Value | Interpretation |
|---|---|---|---|
| RAW | Page ID | TBD bits | Indicates the page index for hierarchical |
| group | | | AID (based on hierarchical AID) of the |
| | | | allocated group |
| | Block | TBD bits | Assuming 32 blocks per page, these bits |
| | Offset | | indicate the starting block index of the |
| | | | allocated group |
| | Block | TBD bits | Indicates the number of blocks (starting |
| | Range | | from the block offset) for the allocated |
| | | | group |
| RAW | RAW | e.g. | 00: single RAW implicit scheduling |
| oper- | oper- | 2 bits | based on RPS-IE |
| ating | ating | | 01: single RAW explicit scheduling |
| mode | mode | | using RA frame |
| indi- | | | 10: multi-RAW operation |
| cation | | | 11: TBD |
| | | | (more bits are needed to support more |
| | | | operating modes) |
| | | | (more bits may also be used optionally |
| | | | to indicate the common RAW operating |
| | | | parameters such as the number and |
| | | | format of subsequent RAWs) |
| RAW | RAW 1 | TBD bits | RAW 1 operating parameters based on |
| oper- | oper- | | RAW operating modes. |
| ating | ating | | e.g. |
| param- | param- | | RAW 1 format (optional) |
| eters | eters | | RAW 1 start time |
| for N | | | RAW 1 duration |
| RAWs | | | Access restriction for RAW 1 |
| | | | Group/RA frame indication for RAW 1 |
| | | | Slot definition for RAW 1 |
| | . . . | . . . | . . . |
| | RAW N | TBD bits | RAW N operating parameters based on |
| | oper- | | RAW operating modes. |
| | ating | | e.g. |
| | param- | | RAW N format (optional) |
| | eters | | RAW N start time |
| | | | RAW N duration |
| | | | Access restriction for RAW N |
| | | | Group/RA frame indication for RAW N |
| | | | Slot definition for RAW N |

The operating parameters subfield for each RAW may indicate the RAW starting time and RAW duration (e.g. in unit of Time Unit, 1024 us), the access restriction for the RAW (i.e. whether the RAW is for paged STA, short frames like poll and trigger, or general frames), whether STAs need to wake up to receive group addressed frames or RA frames at the beginning of the RAW, and slot definition (e.g. slot duration, slot assignment, and whether slot boundary crossing is allowed). When several formats of RAW operating parameters are supported, additional bits may also be used to indicate the RAW format (such as the subfield definitions and length of the RAW operating parameter field).

In the following, the RAW slot protection with CTS (clear to send)/CTS-to-Self will be described.

The IEEE 802.11ah draft standard defines a channel access mechanism named Restricted Access Window (RAW).

FIG. 27 shows an illustration 2700 of the operation of RAW. With RAW, the AP first broadcast RAW Parameter Set (RPS) in the beacon, the RPS Information Element (IE) specifies following parameters:
RAW Group: AID range of STA allowed to access channel in RAW;
RAW Start Time: Medium access start time for group ‘n’;
RAW Duration: Duration of medium access;
Options;
Slot Definition;

Only STAs in the RAW may be allowed to access the channel during the RAW.

For the STA allowed to access the channel, the AP may provide Resource Allocation information at the beginning of the RAW, which may specify the beginning and duration of channel time in slots allocated to each STA and the transmission is for uplink or downlink. STA may wake up at the slot assigned to it and transmit/receive data to/from AP.

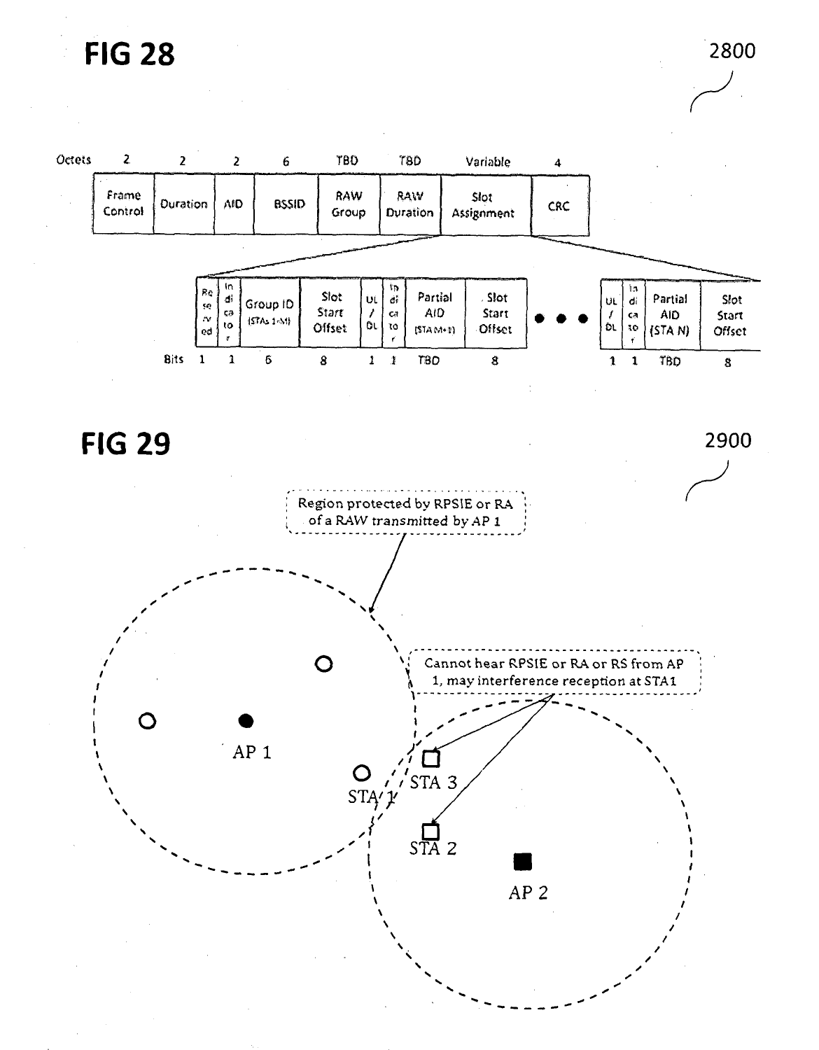

FIG. 28 shows an illustration 2800 of an example RA frame format, and the field may be described as follows:
RAW Group is identical to the group in RPS IE;
RAW Duration is revised from RAW Duration in RPS IE based on PS-Polls and UDIs;
Slot assignment (2 octets/MU Group and TBD octets/STA) defines access slot allocations for STAs:
Independent of TIM bitmap;
1 bit indication for SU-STAs within RAW for UL (bit set to 0) or DL traffic, bit reserved for MU-MIMO group;
Multi-user MIMO supported when multiple STAs are assigned identical slot within RAW.

STA Address may be either a partial AID (TBD bits) or a Group ID (6 bits) for a MU group:
1 bit indicator prior to the address for indication of either partial AID (bit set to 0) or Group ID (bit set to 1).

Slot Start Offset (1 octet) is start time of STA's medium access, relative to the end of the RA frame, in TBD units:
Offset determined by AP based on buffered DL data for STAs from whom PS-Polls were received;
Offset from UDIs indicating amount of buffered traffic.

Within each slot, one or multiple STAs are allowed to access the channel explicitly. In this section, we only consider the case where, for each slot, only one STA is allowed to access the channel.

A problem as will be described in the following may arise.

The channel access mechanism specified by RAW provide a good solution to alleviate contention among STAs in transmitting data, especially when the number is large. However, the protection is constraint by the transmission range of AP that sends the RAW. For downlink, the protection provided by RPSIE or RA of RAW is similar to the protection provided by RTS. Without CTS, the potential collision at the receiver side is not complete. For other STAs associated to other AP and outside the coverage the AP, they may not be able to hear the beacon transmitted by the AP and thus do not know the media reserved by the AP using RAW. For slots with traffic on downlink, i.e., from AP to STA, STAs outside the coverage of AP but within the communication range of the receiving STA may also start transmission on the channel and thus cause collision, especially when the data packet is large.

FIG. 29 shows an illustration 2900 of an example of a potential collision caused by OBSS (Overlapping Basic Service Set) STA in RAW operation.

One way to protect the downlink is to use the legacy RTS/CTS method. However, for 802.11 ah based network, the data rate is rather low comparing to the legacy IEEE 802.11 network. For example, when MCS10 in 1 MHz is used, the link speed is about 150 Kbps. For such a low speed link, to transmit an RTS packet (20 bytes in MAC+PHY+SIFS) takes about 1.88 milliseconds. The overhead is rather significant and it waste the protection provided by RA of RAW.

A solution may be provided and will be described in the following.

To protect a reserved RAW slot from collision with transmission from other STAs without using RTS, AP may indicate that STAs shall provide downlink protection, for some or all STAs addressed by RAW or RA, by setting an DL protection indication field either in RPS IE transmitted in the beacon or in the RA transmitted at the beginning of a RAW.

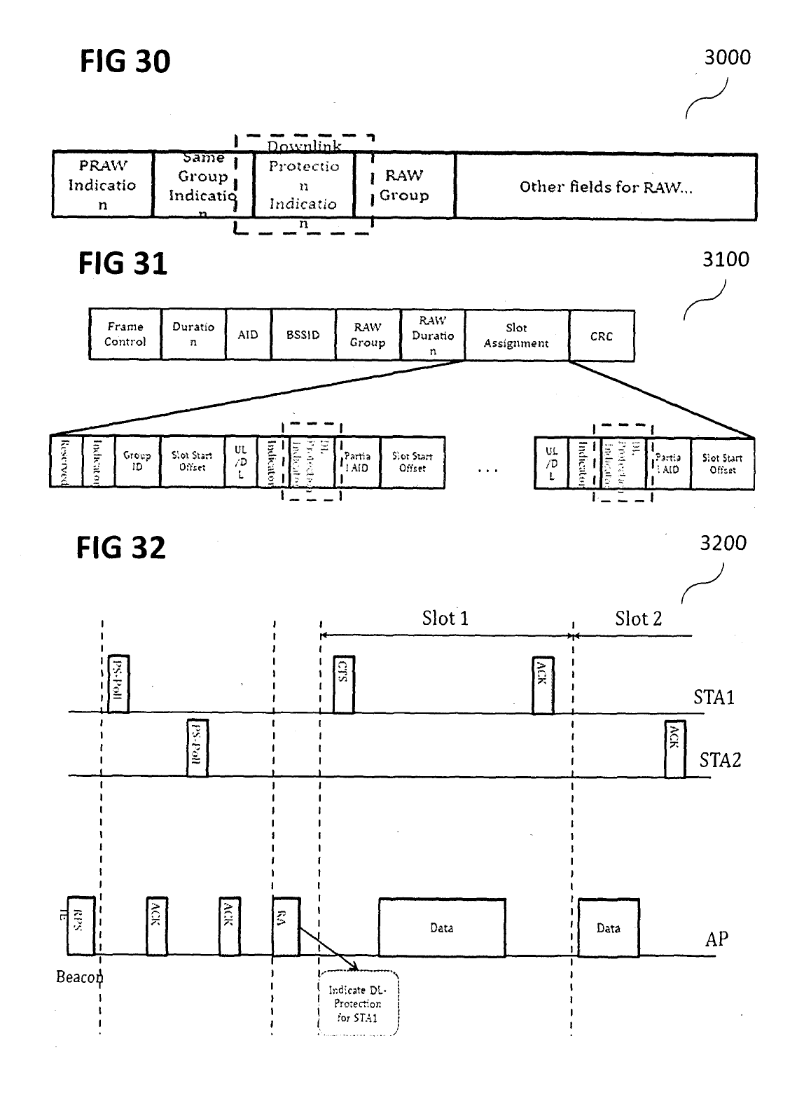

The indication can be a few bits in RPSIE for all STA addressed by RAW as shown in FIG. 30 or a few bits for each RAW group and only the group with downlink protection turned on provides downlink protection. If the bits are not turned on, it may not be necessary for STA to send protection scheme at the beginning of the RAW slots.

FIG. 30 shows an illustration 3000 of an example method for downlink protection indication within a RAW in RPS

If the AP wants to set downlink protection for slots assigned to different STAs, it may indicate downlink protection is required in the slot assignment of an RA as FIG. 31 shows. The downlink protection indication can be one or a few bits. AP may or may not specify the period that it wants the STA to protect.

FIG. 31 shows an illustration 3100 of an example method for downlink protection indication within a RAW in RA.

After receiving the downlink protection indication from AP for downlink RAW slot protection, the relative STA may transmit a media protection frame such as CTS to AP when the slot assigned to it starts. The transmission of protection scheme such as CTS may follow the transmission rule defined by the specification. If the AP has specified the duration that the STA shall protect, then STA may include the period value specified by AP in the RA or RPS IE in the CTS. If AP has not specified a period for protection, STA may specify a period either based on the slot duration or based on the maximum Protocol Data Unit that may be transferred by AP on the downlink. The specified duration may also include necessary interframe time and duration for acknowledgement transmission.

After receiving media protection frame such as CTS from STA, the AP can start to transmit downlink data to STA. If AP does not receive CTS or other protection frame, it may not transmit downlink packet to the STA.

FIG. 32 shows an illustration 3200 of an example where AP specifies downlink protection indication in RA Slot assignment for STA1 (in other words: an example downlink protection indication within a RAW in RPS IE).

In the following, AID assignment and enhancement on implicit RAW slot assignment will be described.

It may be specified that “Use the NDP CTS frame with the Address Indicator field set to 0 and the RA field set to Partial BSSID for sector training. The NDP CTSs with the Address Indicator set to 0 and RA set to Partial BSSID will be transmitted through the Sectorized Beams (with ascending Sector ID starting with Sector ID=0) during the sector training.

An AP should not assign to a SIG STA an AID that results in the PARTIAL_AID value equals to its partial BSSID, if sectorization type 1 is supported.

The implicit RAW slot assignment may define a simple slot assignment procedure for STAs that are allowed to access the medium within a RAW based on the RPS element and the TIM element in a Beacon frame.

A STA may calculate the number of time slots in the RAW (N_{RAW}) by dividing the duration of the RAW (T_{RAW}), which is defined in the RAW Duration field of the RPS element, with the duration (Tₛₗₒₜ) of a time slot in the RAW, which is defined in the Slot Definition field of the RPS element. The time slots in the RAW are indexed from 0 to (N_{RAW}−1) as shown in the following Equation.

The STA shall determine the index of the time slot, iₛₗₒₜ, in which the STA is allowed to start accessing the medium based on the following mapping function:

iₛₗₒₜ=(x+N_{offset}) mod N_{RAW},

where
if the RAW is restricted to STAs whose AID bits in the TIM element are set to 1, x is the position index of the AID of the STA when the AIDs are arranged in ascending order and each AID is assigned with a position index, which starts from 0; x is the AID of the STA, otherwise;
N_{offset} represents the offset value in the mapping function, which improves the fairness among the STAs in the RAW, and the two least significant bytes of the FCS field of the Beacon frame shall be used for the N_{offset}, and
mod X indicates the modulo X operation.

It may be assumed that the AP doesn't assign to the STA with the void AID, which is defined as the AID
with the assignment resulting in the PARTIAL_AID value, as computed using Equation (9-8a) (defined in IEEE 802.11ac Draft 3.0), being equal to either (dec(BSSID[39:47]) mod (2⁹−1))+1 or (dec(Overlapping BSSID[39:47]) mod (2⁹−1))+1, or
being equal to AP's Partial BSSID i.e. dec(BSSID[39:47]), or
Other cases TBD.

There may be some unassigned valid AIDs in the RAW group as indicated in Raw Parameter Set IE. The unassigned valid AIDs should not be considered for implicit slot allocation in order to improve slot usage efficiency and/or the fairness of equal slot access opportunity for the STAs considered in the RAW. Some STAs may disassociate with the AP so that their AIDs become invalid (unassigned valid AIDs) so that there may be some “holes” in the AIDs for the RAW group. Although AID re-assignment is helpful, the overhead (the frame exchange time) of AID reassignment can't ensure there are no unassigned valid AIDs in the range of RAW group as indicated in the RPS IE. Note that if the improvement is not adopted, some slots may be shared with more STAs while other slots may be empty. At the same time, the non-empty slots may be shared by different number of STAs, which causes the unfairness of slot access opportunity for the STAs in the RAW group.

The both cases are considered as the unassigned AIDs. We need to change the implicit time slot allocation, taking into account the possibility of the empty slots that will be wasted if the slots are allocated to the unassigned AID but are not shared with any assigned valid AID. The following modified allocation is only for the RAW group including the unassigned AIDs (unassigned void AIDs and unassigned valid AIDs).

Since there are unassigned AIDs i.e. void AIDs that are defined as the AID that should not be assigned to a S1G STA and unassigned valid AIDs in the RAW group, when RAW is not restricted to STAs whose AID bits are set to 1, if the unassigned AIDs are not considered for implicit slot allocation, the STA computes its allocated slot using the modified mapping function.

iₛₗₒₜ=(x−k+N_{offset}) mod N_{RAW},

where x is the AID of the STA, If the RAW is restricted to STAs whose AID bits in the TIM element are set to 1, k=0; otherwise k is the number of unassigned AIDs in the RAW group that is smaller than x.

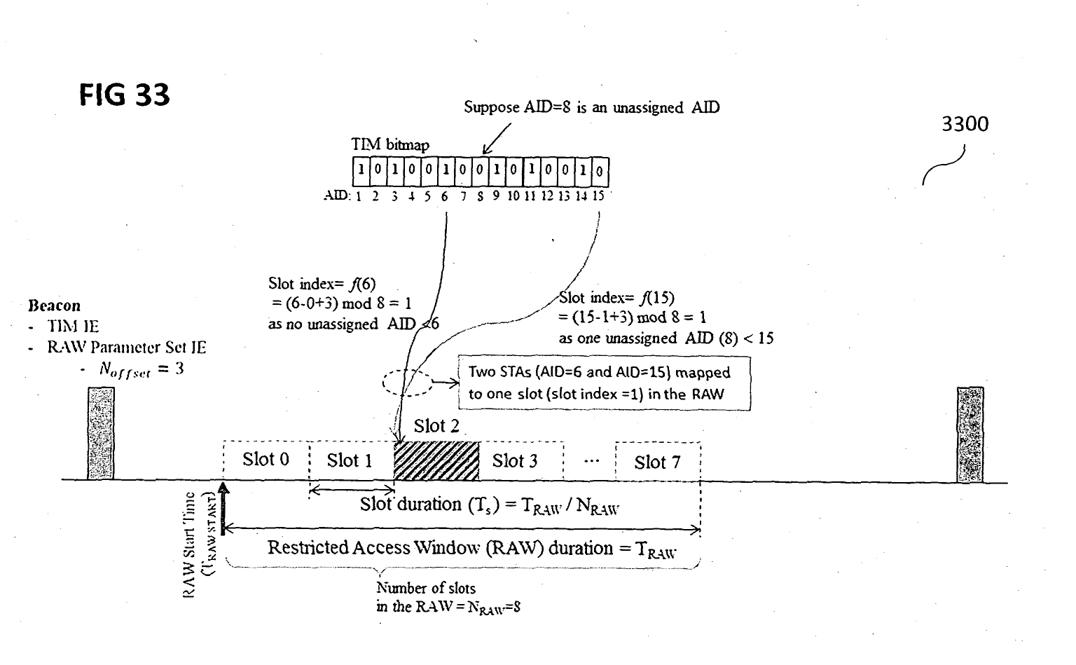

FIG. 33 shows an illustration 3300 of an implicit RAW slot assignment with unassigned AIDs: FIG. 33 illustrates one example of implicit RAW slot assignment with one unassigned AID (assume either a void AID or an unassigned valid AID is 8 in this example) for TIM bitmap indicating AID range from 1 to 15 in the beacon. There are two AIDs that are allocated to share the slot with index equal to 2. When the unassigned AID is 8, there is no unassigned AID that is smaller than 6 for the STA with AID equal to 6 (applying the implicit slot allocation equation iₛₗₒₜ=(x+N_{offset}) mod N_{RAW}) and there is an unassigned AID that is smaller than 15 for the STA with AID equal to 15 (applying the implicit slot allocation equation of iₛₗₒₜ=(x−1+N_{offset}) mod N_{RAW}) so that two STAs with AID=6 and AID=15 sharing the same slot with index equal to 2.

AP may signal to STA that the unassigned AIDs are not considered for implicit slot allocation during association or through its capability element in the beacon. The unassigned void AIDs could be fixed if there is no change on overlapping BSSs. AP may indicate overlapping BSSID to the non-AP STA explicitly for the non-AP STA to derive the void AIDs.

The unassigned AIDs may be also explicitly indicated in the RAW Parameter Set IE, or other IE attached to the beacon, or computed and tracked by the STAs, or other frame exchange. For example, we may define an unassigned AID IE to include the unassigned AIDs that are not considered for the implicit slot allocation in the RAW(s) e.g. by using AID differential encoding method to encode the bitmap of unassigned AIDs or simply encode the direct AID (13 bits) into the IE. The unassigned AID IE may include a field (e.g. action indication) to indicate whether the unassigned AIDs in the IE are added (e.g. void AIDs are not considered due to new overlapping BSSs and/or un-assignment of the valid AIDs due to disassociation of the STAs), updated (used to replace the old list of unassigned AIDs) or removed (e.g. void AIDs becomes valid due to removal of overlapping BSSs, unassigned valid AID is used due to AID re-assignment), for example like will be described in the following.

The unassigned AID IE indicates the list of unassigned AIDs in the RAW(s) that are not considered for slot allocation. This IE

a) may include unassigned valid AIDs;

b) may include unassigned void AIDs;

c) may include Action field to indicate the following actions for the STAs to take: “add”, “replace”, “remove”:

i) Add: add the unassigned AIDs in the IE into the list of unassigned AIDs kept track by the non-AP STA;

ii) Replace: replace the list of unassigned AIDs kept track by the non-AP STA with the unassigned AIDs in the IE;

iii) Remove: remove the unassigned AIDs in the IE from the list of unassigned AIDs kept track by the non-AP STA.

This unassigned AID IE may include:
IE ID, Length, Action, Encode Word Length, Encoded Differential AID values, Padding;
IE ID, Length, Action, Bitmap Control, Encoded Block for void AIDs;
IE ID, Length, Action, Direct AID values (each with 13 bits), Padding;
IE ID, Length, Action, Direct AID values (each with 16 bits).

The STA may keep track of the unassigned AIDs in the RAW group. If it is in the same RAW group as the unassigned AID, it should apply the above modified allocation approach to avoid the empty slot allocation for the unassigned AID.

In the following, RAW protection will be described.

Referring back to the previous description, a further introduction to RAW will be given. Restricted Access Window (RAW) is an important feature for 802.11 ah standard amendment. It is defined as a period of channel time within which only specified group of STA is allowed to access the channel. When this feature is supported, an AP may broadcast an RAW Parameter Set (RPS) IE in a beacon which specifies, one or more RAW period. A Resource Allocation (RA) frame may be broadcasted at the beginning of the RAW to further indicate the assignment of a RAW slot. FIG. 28 shows the format of RA frame (in other words: FIG. 28 shows a frame format for resource allocation frame).

A problem like described above may arise.

A solution like will be described in the following may be provided.

To protect the downlink transmission within a RAW slot, as described above, device and methods may be provided to include one bit in the RAW slot to indicate to a non-AP STA to transmit a CTS at the beginning of the slot. FIG. 31 shows this design and shows and indicator for RAW protection.

The protection scheme may be further expanded by including more possible solutions to the design.

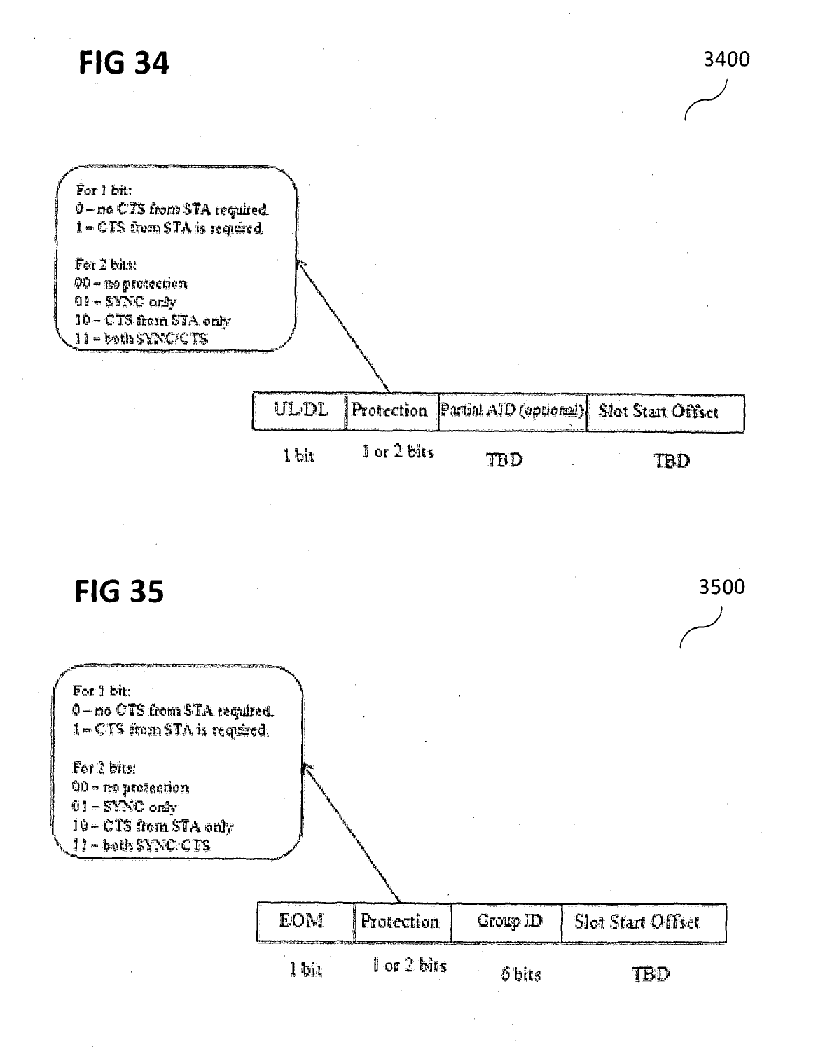

As described above, one bit may be used to indicate DL protection. However, the indication may further be expanded to two bits. The two bits may be used to indicate that no protection is required for the downlink transmission, protection with SYNC frame (SYNC frame is CTS frame as defined by 802.11 ah 0.1 draft) only, protection with CTS from STA only, or both SYNC and CTS are required to protect the DL transmission. For example, when the values of the two bits are “00”, no protection is required. STA just waits for the data frame from AP. When the values of the two bits are “01”, AP transmits a SYNC frame at the beginning of the slot. When the values of the two bits are “10”, STA transmit a CTS frame at the beginning of the slot before AP can send a downlink frame to the STA. When the values of the two bits are “11”, AP sends a SYNC frame to the STA first and then STA send CTS frame to AP. After receiving the CTS, AP can transmit the data to STA. FIG. 34 shows the possible example of slot allocation with protection indication bits.

FIG. 34 shows an illustration 3400 of an example of RAW Slot protection indication (Slot assigned to single STA).

When Group Indicator in the slot assignment is set to one, the following slots are assigned to a group of stations. MU-MIMO technology may be used by AP to send multiple packets to the STAs. Similarly, 1 or 2 bits in the RA frame might be to indicate whether protection is needed. In case 1 bit is used, it is used to indicate whether CTS from STA is required or not to protect the transmission from AP on the downlink using MU-MIMO technology to the group of STAs specified by the group ID. For example, 0 indicates that STAs in the MU-MIMO group is not required to transmit CTS to protect the downlink transmission. On the other hand, if the bit is set to one, one of the STA in the MU-MIMO downlink group specified by the group ID is required to transmit CTS frame to AP. The STA that transmits the CTS frame is predetermined when the group is setup. If two bits are used in the indication, they can be used to indicate that CTS is not required, SYNC from AP only, CTS from STA only and both SYNC and CTS from AP and STA are required. For example, 00 indicates that no protection for the slot is required; 01 indicate that SYNC frame will be transmitted by AP; 10 means one of the STA shall transmit a CTS frame to protect the slot and 11 means both SYNC and CTS are required. AP transmits downlink data directly to the STAs specified by the group after the required SYNC/CTS frames are transmitted/received. FIG. 35 shows an example of slot allocation with protection indication bits when it is used when slots are assigned to a group of STAs.

FIG. 35 shows an illustration 3500 of an example of RAW Slot protection indication (Slot assigned to single STA).

In the following, a unified field format for RAW/AP PM RAW (access point power saving mode RAW)/PRAW (periodic RAW)/Sounding RAW according to various embodiments will be described.

In the IEEE 802.11 draft specification, Restricted Access Window (RAW) has been defined to reduce the contention from large number of STAs. The RAW may be mainly defined for the stations in Power Saving mode that listens to beacon from time to time. To facilitate the channel access for those low power STAs who do not listen to the beacon, or non-TIM STA as defined in the specification, Periodic RAW (PRAW) is defined. To support beamforming, sounding RAW is defined.

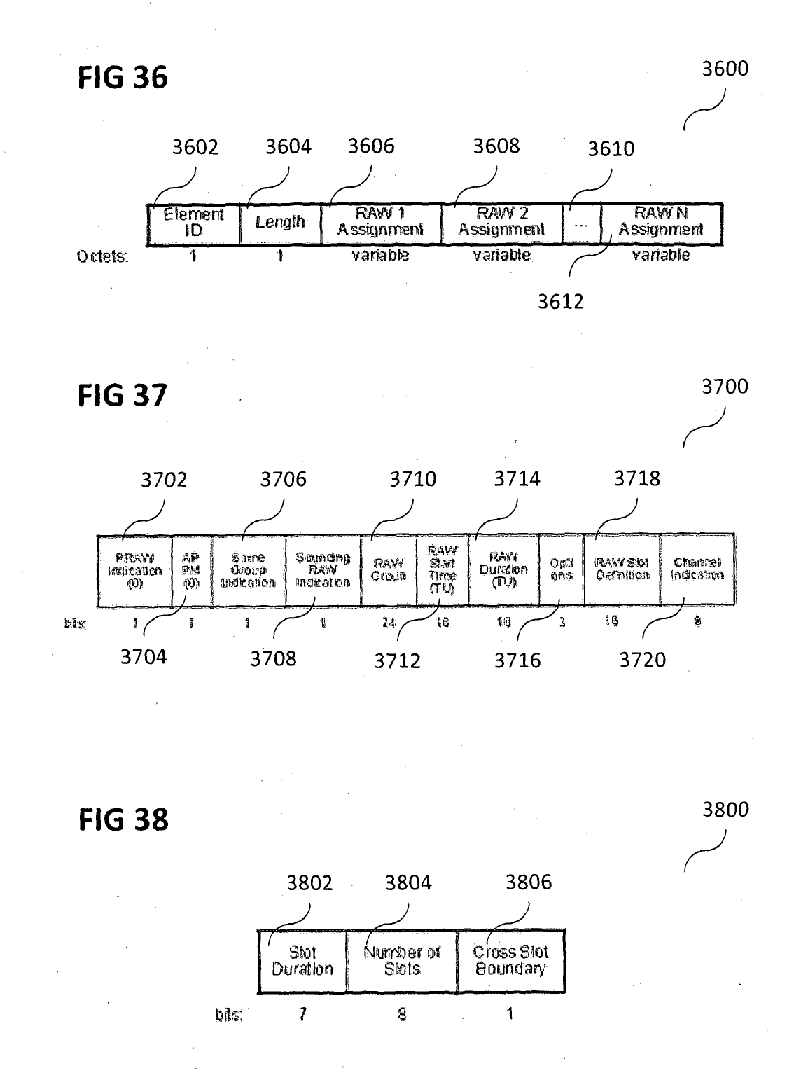

The information for RAW, RAW for AP PM, Periodical RAW, Sounding RAW may be broadcasted to the network with RAW Parameter Set (RPS) Information Element beacon message. The format of the RPS message is shown in FIG. 36.

FIG. 36 shows an illustration 3600 of a format of RPS information element according to various embodiments, in which an element ID field 3602 of e.g. one octet, a length field 3604 of e.g. one octet, an a plurality of RAW assignment fields 3606, 3608, 3610, 3612 of variable length may be provided.

RAW Assignment fields defined for RAW, AP PM RAW, PRAW and Sounding RAW may have different formats and a few bits in the RAW Assignment field may be used to differentiate the different RAW types.

FIG. 37 shows an illustration 3700 of the subfield defined for Regular RAW (for example a format of RAW N assignment Field for RAW). It may have 5 control fields and 8 data fields. The 5 control fields may be:
PRAW Indication 3702: a 1-bit subfield that indicates whether the RAW is RAW or PRAW. When PRAW Indication is set 0, the RAW is not a PRAW. When PRAW Indication is set to 1, the RAW is a PRAW.
AP PM 3704: a 1-bit subfield that indicates whether the RAW is for AP in Power Saving Mode. When AP PM is set to 0, the RAW is not a AM PM RAW. When AP PM is set to one, the RAW is an AP PM RAW and AP will be in doze during the time period specified by this AP PM RAW.
Same group indication 3706: a 1-bit subfield that indicates whether a RAW Group field appears;
Sounding RAW 3708: a 1-bit subfield that indicates whether the RAW is used for channel sounding; and
Start Time Indication: a 1-bit subfield that indicates whether the Start Time field 3712 (like will be described below) appears.

The 8 data fields may be:
RAW Group 3710: a 24-bit subfield specifies the nodes that can access the channel;
RAW Start Time 3712: a 16-bit subfield the start time of RAW (for example given in time units (TU));
RAW Duration 3714: a 16-bit subfield specifies the duration of RAW;
Option filed 3716: a 3-bit subfield defined for regular RAW. It consists of three subsubfields, Access Restriction, Frame Type and Resource Allocation Frame Presence Indication.
Access Restriction: 1-bit subfield to specify whether non-paged STA can access the channel during the RAW;
Frame type: indicating whether the frame can be longer than a slot;
Resource Allocation Frame Presence Indication: indicating whether the resource allocation frames appears at the beginning of RAW;
RAW Slot Definition 3718: a 16-bit subfield defines the slot; including slot number, slot duration and whether cross slot boundary is allowed. FIG. 38 shows the definition of RAW Slot definition.
Channel Indication 3720: channel bitmap that this RAW applies. The Channel Indication field contains a bitmap allowing the identification of allowed operating channels for the STAs indicated in the RAW. Each bit in the bitmap corresponds to one minimum width channel within the current BSS operating channels, with the least significant bit corresponding to the lowest numbered operating channel of the BSS.

FIG. 38 shows an illustration 3800 of the slot definition, wherein a slot duration field 3802 of e.g. 7 bits, a number of slots field 3804 of e.g. 8 bits, and a cross slot boundary field 3806 of e.g. 1 bit may be provided.

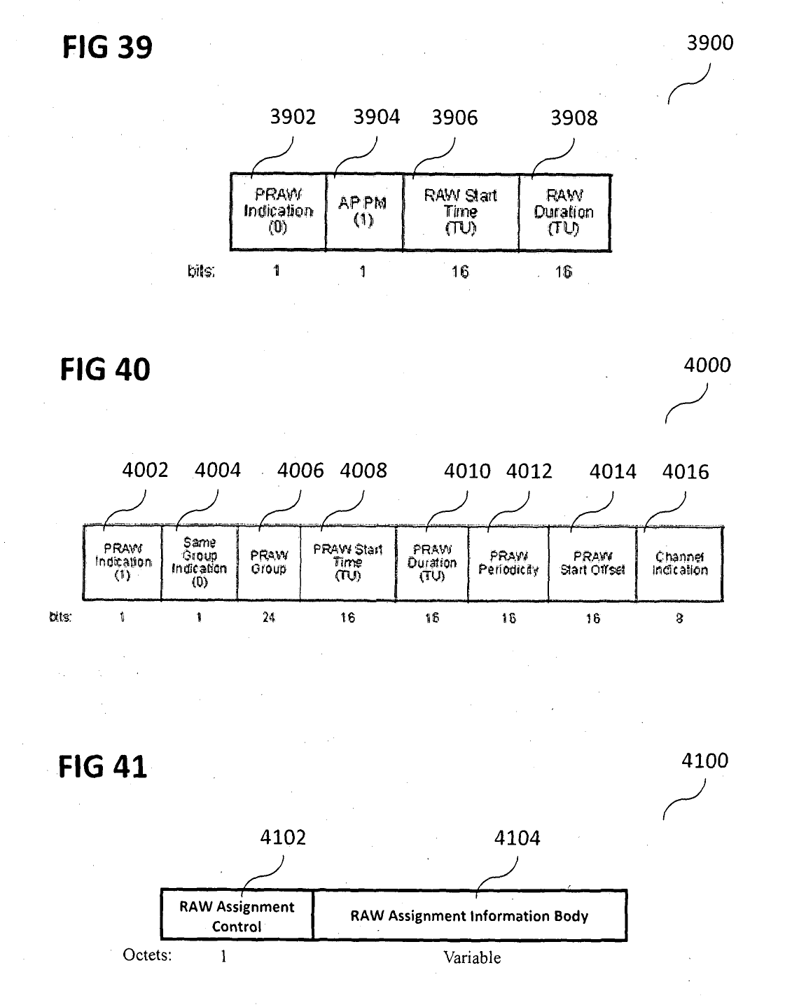

FIG. 39 shows an illustration 3900 of a format of RAW N assignment field for AP PM RAW. FIG. 39 shows the subfields for RAW defined for AP in Power Saving (PM) mode. It only contains two control fields, PRAW indication 3902 and AP PM 3904 indication. It includes two data fields, RAW Start Time 3906 (for example given in TU) and RAW Duration 3908 (for example given in TU).

FIG. 40 shows an illustration 4000 of the RAW N format for PRAW. It includes two control bits, PRAW indication 4002 and Same Group Indication 4004. It includes 6 data fields, PRAW Group 4006, PRAW Start Time 4008, PRAW Duration 4010, PRAW Periodicity 4012 (of e.g. 16 bits), PRAW Start Offset 4014 (of e.g. 16 bits), and Channel Indication 4016.

The formats for different types of RAW such as RAW/PRAW/AP PM RAW/Sounding RAW are not well organized. The control bits defined for different RAW types can be combined. Some of fields can be shortened, such as RAW Start Time/RAW Duration subfields. Some of the subfields can be made optional, for example, the channel indication subfields. It may be better if a unified frame format can be defined to put all four types of RAW in one framework and reduce the potential overhead. The advantage may be that it not only will ease the implementation, but also can reduce the signaling overhead.

Resource allocation frame defined in the current draft specification also contains redundant or incorrect information. It may be further improved.

In the following, a unified definition for RAW/PRAW/Sounding RAW according to various embodiments will be described.

In the following, a unified format defined for regular RAW/AP PM RAW/PRAW/Sounding RAW according to various embodiments will be described.

Based on the existing work, there may be four types of RAW definition; they may be regular RAW, AP PM RAW, PRAW and Sounding RAW. There may be some control fields and some data fields for different RAWs. Therefore, device and methods according to various embodiments may have unified the RAW Assignment field structure as shown in FIG. 41.

FIG. 41 shows an illustration 4100 of a unified structure for RAW assignment field according to various embodiments, including a RAW assignment control field 4102 of e.g. one octet, and a RAW assignment information body field 4104 of e.g. variable size.

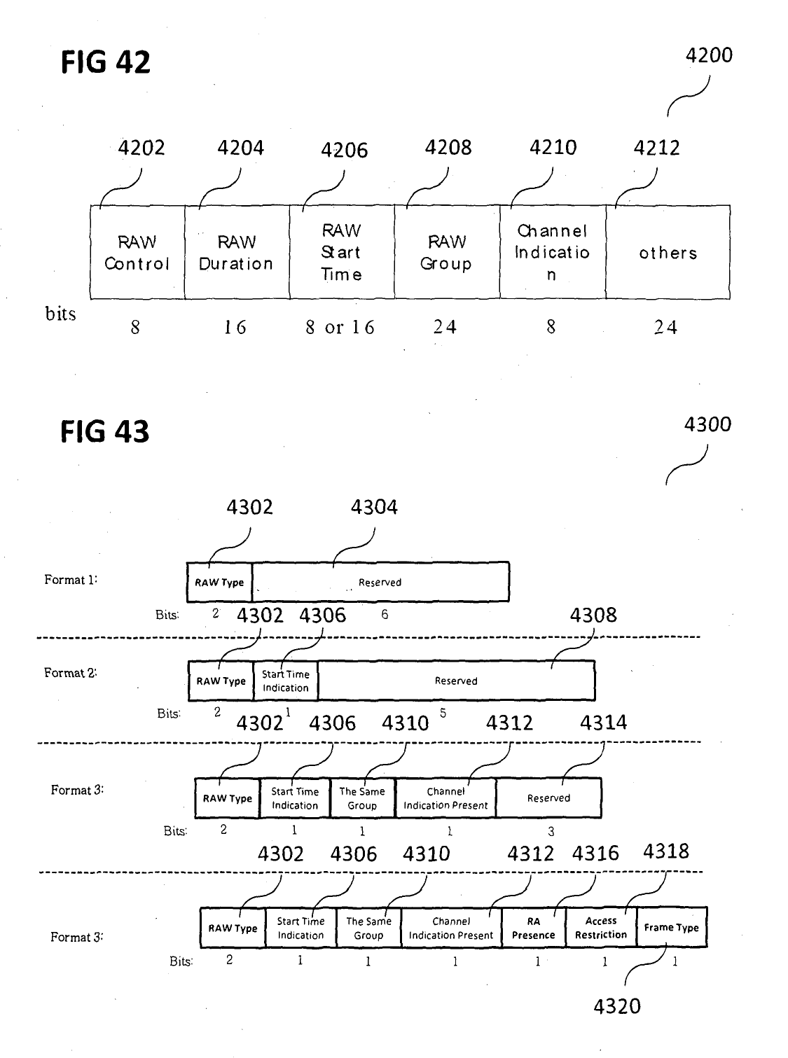

FIG. 42 shows an illustration 4200 of a RAW assignment field format according to various embodiments. The RAW Assignment field may include RAW Control 4202, RAW Slot Definition, RAW Duration 4204, RAW Start Time 4206 (which may be conditionally present), RAW Group 4208 (which may be conditionally present), Channel Indication 4210 (which may be conditionally present) and others subfields 4212.

The RAW Assignment Control subfield, which can be one or more octets, may include the control bits for different RAW types such as RAW type, the same group, PRAW/Sounding RAW, or some option bits etc. RAW Assignment Information Body contains various information such as RAW Start Time, RAW Duration, Channel Indication etc.

When the RAW Assignment is more than one octet, the option field may be used to indicate the extension of the RAW Assignment.

In the following, a definition of the RAW control subfields according to various embodiments will be described.

FIG. 43 shows an illustration 4300 of a definition of RAW control subfield according to various embodiments. FIG. 43 shows the possible formats of the RAW control subfields (for example four possible formats, one format in each line divided by a dashed line). The RAW control subfield may be 8 bits in length.

The first 2 bits of the RAW Assignment Control subfields may be a 2-bit subfield named RAW type 4302. It may be used to differentiate the types of RAW. One embodiment of the RAW types can be, Regular RAW, Sounding RAW, AP PM RAW and PRAW. Each of them takes a different value from 00, 01, 10 and 11 in binary. For example, Regular RAW may be represented by 00, Sounding RAW is represented by 01, AP PM RAW is represented by 10 and PRAW is represented by 11.

According to various embodiments, the RAW Type may be 2 bits in length and may indicate the type of the RAW Assignment. There may be four RAW types: Regular RAW, Sounding RAW, AP PM/Non-TIM RAW and others as Table 9 shows.

TABLE 9
RAW Type.

RAW Type

| Bit 0 | Bit 1 | Description |
|---|---|---|
| 0 | 0 | The RAW is a Regular RAW. |
| 0 | 1 | The RAW is a Sounding RAW. |
| 1 | 0 | The RAW is an AP PM/non-TIM RAW. |
| 1 | 1 | others |

When the RAW Type is Regular RAW, it may be used to schedule the channel access for TIM STA.

When the RAW Type is Sounding RAW, it may be used for channel sounding.

When the RAW Type is AP PM RAW/non-TIM RAW, the RAW may either be used for AP Power Management or used for reserving channel time for non-TIM STAs, depending on the values of RAW Type Options subsubfield.

When the RAW is used as the non-TIM RAW, the access may be restricted to non-TIM STAs such as TWT STAs or doze awake cycle rescheduled STAs. The RAW Assignment subfield for non-TIM RAW conditionally may include the RAW Start Time, Channel Indication, and Periodic Operation Parameters subfields.

When the RAW is used as the AP PM RAW, the RAW Assignment subfield for AP PM RAW may also conditionally include the RAW Start Time, and Periodic Operation Parameters sub-subfields.

Another possible embodiment for the definition of the RAW type is, 00 represents regular RAW without RA frame at the beginning of RAW; 01 represents regular RAW without RA frame at the beginning of RAW; 10 represents PRAW and 11 represents sounding RAW.

For the rest of the bits in the RAW Control subfields, one way is to leave it as reserved bits 4304 and let each RAW subtype to define for them own as shown in FIG. 43 Format 1 (first line of FIG. 43).

The second possible format for RAW control field definition is to add one subfield, Start Time Indication 4306 after the RAW type. FIG. 43, format 2 shows an example of this format. This field may be common to all RAW types. If it is set to zero, Start Time may not appear in the RAW information body; else, Start Time may appear in the RAW Assignment Information Body. The rest of the bits may be provided as a reserved field 4308.

The third possible format (e.g. Format 3 in FIG. 43) for RAW control field definition may be to include three subfields after RAW types 4302, Start Time Indication 4306, The Same Group 4310, and Channel Indication Presence 4312. These subfields may be common to all four RAW types. The Same Group 4310 may indicate whether the Group field appears in the RAW information body. The Channel Indication Presence subfield 4312 may indicate whether the channel Indication field appears in the RAW Information body. If it is set to zero, it indicates the Channel Indication subfield does not appear in the RAW Assignment Information Body. If it is set to one, it indicates the Channel Indication subfield appears in the RAW Assignment Information Body. But some of the RAW types may ignore the meaning of some of the fields. For example, AP PM RAW may ignore The Same Group 4310 and Channel Indication Presence 4312 fields. One example of the format for this type is shown in FIG. 43 Format 3. The RAW Control subfield may be 8 bits in length and may include RAW Types 4302, Start Time Indication 4306, Channel Indication Presence 4312 and other fields (including a reserved field 4314).

The Start Time Indication 4306 may be of length 1 bit and it may indicate whether the RAW Start Time Subfield in the current RAW Assignment is present or not. If it is set to zero, the RAW Start Time subfield is not present. If it is set to one, the RAW Start Time subfield is present.

The Same Group Indication 4310 may be of length 1 bit and it may indicate whether the RAW Group defined in the current RAW Assignment is the same RAW Group as defined in the previous RAW Assignment. When the Same Group Indication bit is set to 1, the RAW Group defined in the current RAW Assignment may be the same as the RAW Group defined in the previous RAW Assignment and the RAW Group subfield is not present in this RAW assignment. When the Same Group Indication 4310 bit is set to 0, the RAW Group defined in the current RAW Assignment is different from the RAW Group defined in the previous RAW Assignment and the RAW Group subfield is present in this RAW assignment.

The Channel Indication Presence 4312 may be of length 1 bit and it may indicate whether the Channel Indication Subfield in the current RAW Assignment is present or not. If it is set to zero, the Channel Indication subfield is not present. If it is set to one, the Channel Indication subfield is present.

The fourth possible format for RAW control field definition (e.g. Format 4 in FIG. 43) may be to include 6 more subfields after the RAW type subfields. These fields may be Start Time Indication 4306, The Same Group 4310, and Channel Indication Presence 4312, RA Presence 4316, Access Restriction 4318 (e.g. Paged STA), and Frame Type 4320. Different RAW types may just code/decode control bits that are relevant. For those irrelevant bits, they are ignored in the encoding and decoding. For example, when the RAW type is set to AP PM, The Same Group bit is ignored during encoding and decoding. One example of the format for this type is shown in FIG. 43 Format 4.

For the RAW Control subfield format according to various embodiments, all the subfields such as for example The Same Group 4310, Channel Indication 4312 etc. may be present with an order different from those described with reference to FIG. 42.

In the following, encoding of the RAW information body according to various embodiments will be described.

The RAW Assignment Information Body subfield may include subfields for different RAW types, the subfields including RAW Start Time, RAW Duration, Slot Definition, RAW Group, Channel Indication, PRAW Periodicity, and PRAW Start Offset.

Slot Definition may be defined for regular RAW and may be used only when RA does not appear. From the slot definition, the station may be able to derive the slot duration. Therefore, when slot definition is available, the slot duration field may not be necessary.

For the RAW Start Time subfield and RAW duration subfield, in the current draft specification, each of them uses 16 bits. However, when the beacon interval is short, it is not necessary to use 16 bits, and 8 bits are good enough since a RAW is limited within a beacon interval. 8 bits can cover up to 255 TU. Therefore, when beacon interval is shorter than 255 TU, then AP may encode the RAW Start Time and RAW Duration field with 8 bits. When the beacon interval is longer than 255 TU, then AP may encode the RAW Start Time and RAW Duration fields with 16 bits. Beacon Interval is usually put in each beacon, therefore, based on the value of Beacon Interval within a beacon message, a STA can derive how many bits, i.e. 8 or 16 bits, are used to code the RAW Start Time and RAW duration field.

With different types of RAWs, there are totally seven subfields that may appear in the RAW Assignment Information Body subfield. The seven fields may be RAW/PRAW Start Time, RAW/PRAW Duration Field, RAW/PRAW Group, Slot Definition, Channel Indication, PRAW Periodicity, and PRAW Start Offset. To facilitate the decoding of the RAW information body, a pre-determined order may be provided, for example as shown in FIG. 45.

FIG. 45 shows an illustration 4500 of a decoding order of the RAW information body according to various embodiments. The arrangement of these subfields in the RAW Assignment Information Body subfields may be as follows (besides a RAW field 4502 of e.g. 8 bits):
Start Time 4504 (for RAW and PRAW): Start Time subfield may be the only subfields that requires by all four types of RAW. Therefore, it may be put as the first subfield after the RAW Control. It may appear when Start Time Indication in RAW Control subfields is set to 1 and do not appear when Start Time Indication subfields is set to zero. It shall be the first subfield after the RAW Control subfields.
Duration 4506 (for RAW/PRAW): duration field may be necessary for all four RAW types. But when RAW type is set to zero, or the RAW is regular RAW, the RAW duration can be derived from the slot definition by multiple the value of Slot Duration subfields with Number of Slots in the Slot Definition Subfields. Therefore, when RAW type is set to zero, Duration field may not be necessary and thus may not appear in the RAW Assignment Information Body; in all other cases, the Duration field appears. Similar to the Start Time filed, the number of bits used for RAW Duration can be either 8 or 16, depending on whether the Beacon Interval is longer than 255 TU. The RAW Duration indicated by the corresponding RAW Assignment may be calculated as follows:

RAW Duration=Slot Duration×120 us×Number of Slots.

The RAW Duration indicates the duration, unsigned integer in microsecond, of restricted medium access assigned to a RAW.
Slot Definition 4508: Slot Definition subfield after Start Time 4504/Duration 4506 subfields when RAW type may be set to zero. Else, it does not appear. The number of bits for this field may be 16 as defined in the draft. Duration 4506 and Slot Definition 4508 subfields may be exclusive to each other.
Group 4510 (RAW/PRAW): this subfield may follow the Duration 4506 or Slot Definition 4508 subfields and may appear when RAW type is set to 0, 2, and 3 and The Same Group filed in the RAW Control subfield is set to 0. Else, it does not appear in the RAW information body. The size of this subfield may be 24 as defined in the draft specification.
Channel Indication 4512: this subfield may appear when RAW Type is set to 0, 2, and 3, and the Channel Indication Presence subfield in the RAW Control subfield may be set to 1. Else it does not appear. The length of the subfield may be 8 bits. The Channel Indication field may include or may be a bitmap allowing the identification of allowed operating channels for the STAs indicated in the RAW. Each bit in the bitmap may correspond to one minimum width channel within the current BSS operating channels, with the least significant bit corresponding to the lowest numbered operating channel of the BSS.
PRAW Periodicity 4514: this field may appear only when RAW type is set to 2, or the RAW is a PRAW.
PRAW Start Offset 4516: this field may appear only when RAW type is set to 2, or the RAW is a PRAW.

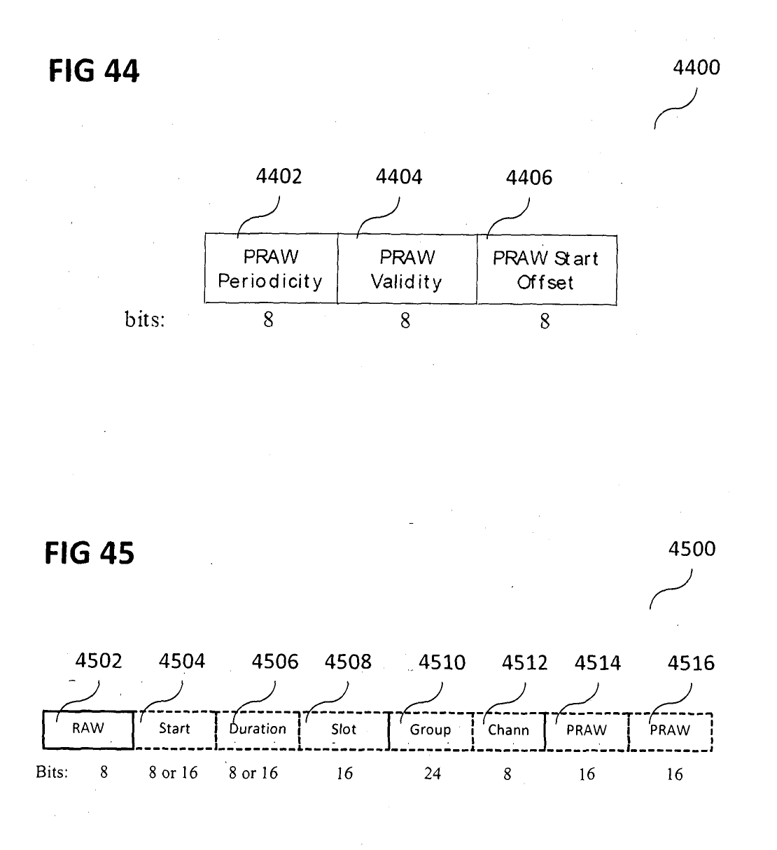

FIG. 44 shows an illustration 4400 of periodic operation parameters according to various embodiments. The Periodic Operation Parameters subfield as shown in FIG. 44 may be of e.g. 24 bits in length and may include the PRAW Periodicity 4402, PRAW Validity 4404, and PRAW Start Offset 4406 sub-subfields.

The PRAW Periodicity sub-subfield 4402 may indicate the period of current PRAW occurrence in the unit of short beacon interval, and may e.g. be of length 8 bits.

The PRAW Validity sub-subfield 4404 may indicate the number of periods that the PRAW repeats, and may be e.g. of length 8 bits.

The PRAW Start Offset sub-subfield 4406 may indicate the offset value in TU from the end of the (Short) Beacon frame that the first window of the PRAW appears from, and may e.g. be of length 8 bits (Reference point details may be TBD).

When encoding various subfields, the encoder may encode the subfields in the order shown in FIG. 45. If one field appears, the encoder encodes the field with number of bits required, else, then the encoder skips the field and move to encode the next subfield until the encoding process ends.

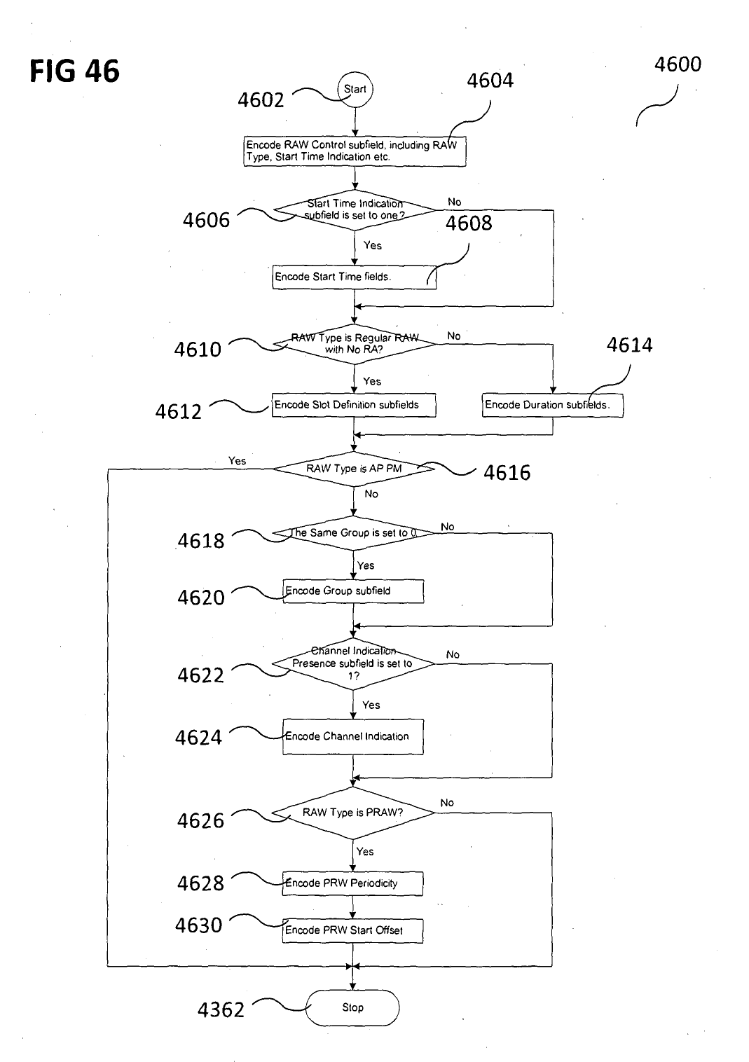

FIG. 46 shows a flow diagram 4600 illustrating an encoding method for a RAW field according to various embodiments. The method may start in 4602. For example, in 4604, the encoder first may encode the RAW Control subfields and set appropriate values for RAW Type, Start Time Indication etc. After that, it may check in 4606 whether Start Time shall be encoded or not (in other words, whether start time indication subfield is set of one: if it is set to one, processing may proceed in 4608, otherwise in 4610). Based on the status of Start Time Indication, if it shall be present, then the encoder may encode the RAW start time value with number of bits required, 8 or 16 bits, in 4608. If it shall not be present, then the encoder move on to encode the Duration Fields/RAW Slot Definition subfields. The encoder repeats the procedure for each subfield as shown in FIG. 46 until all the subfields that shall appear being included. When all the subfields that shall appear are included, the encoder can stop the encoding for this RAW field. In 4610, it may be determined whether RAW type is regular RAW with no RA; if so, processing may proceed in 4612, otherwise in 4614. In 4612, slot definition subfield may be encoded. In 4614, duration subfields may be encoded. In 4616, it may be determined whether RAW type is AP PM; if so, processing may stop in 4362, otherwise processing may proceed in 4618. In 4618, it may be determined whether the same group is set to 0; if so, processing may proceed in 4620, otherwise processing may proceed in 4622. In 4620, the group subfield may be encoded. In 4622, it may be determined whether channel indication subfield is set to 1; if so, processing may proceed to 4624, otherwise processing may proceed to 4626. In 4624, the channel indication may be encoded. In 4626, it may be determined whether the RAW type is PRAW; if so, processing may proceed in 4628, otherwise, processing may stop in 4362. In 4628, the PRW (in other words: PRAW) periodicity may be encoded. In 4630, the PRW start offset may be encoded.

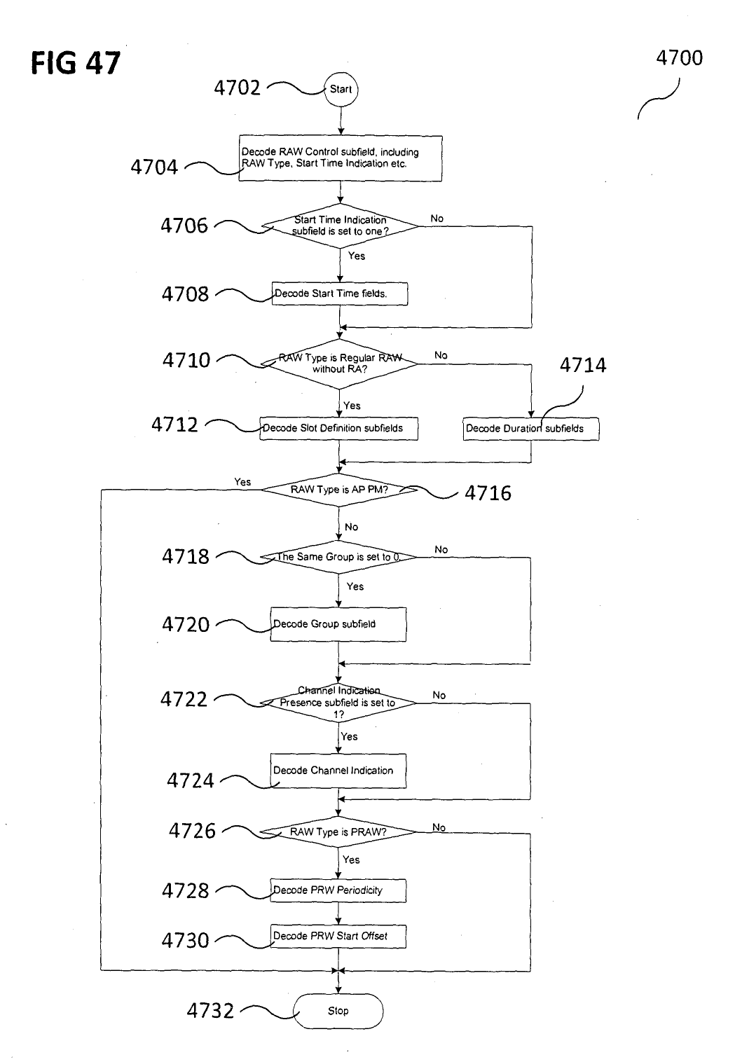

FIG. 47 shows a flow diagram 4700 illustrating a decoding method for a RAW field according to various embodiments. When decoding the RAW field, the decoder may follow part of or the whole method illustrated in FIG. 47, for example as follows. The method may start in 4702. In a first step, the decoder may decode the RAW type and other control subfields within the RAW Control subfields in 4704. Based on the RAW type and values for each control subfield, the decoder may determine whether different subfields appear or not, and their length if they appears. After that, go to next step. In a second step, the decoder may decode the value of Start Time (4708) if it appears (as determined in 4706) and then goes to next step; if the Start Time field does not appear, then it goes to next step; The length of this subfield may be known from the value of the Beacon Interval. If beacon interval is less than 255 TU, then Start Time may be encoded with 8 bits; else, it is encoded with 16 bits. In a third step, the decoder may decode the Duration/Slot Definition (4712, 4714) if either of them appears (as determined in 4710), and move to next step. In a fourth step, if AP PM is set to zero (as determined in 4716), then move to next step in 4718, else, end the decoding in 4732. In a fifth step, the decoder may decode the value of Group subfield (4720) if it appears (as determined in 4718) and may then move to next step; else, move to next step. In a sixth step, the decoder may decode the value of Channel Indication subfield (4724) if it appears (as determined in 4722) and then move to next step 4726; else, move to next step 4726. In a seventh step, the decoder may decode the value of PRAW Periodicity subfield 4728 if it appears (as determined in 4726) and then move to next step 4730; else, move to next step 4732. In an eighth step, the decoder may decode the value of PRAW Start Offset subfield (4730) if it appears (as determined in 4726) and then move to next step; else stop the decoding for this RAW field in 4732.

In the following, an extension of same group indication according to various embodiments will be described.

The Same Group Indication may be of length 1 bit and it indicates whether the RAW Group defined in the current RAW Assignment is the same RAW Group as defined in the previous RAW Assignment. In the case of PRAW, it may indicate whether the PRAW Group defined in the current RAW assignment is the same PRAW Group as defined in the previous RAW Assignment.

For RAW, when the Same Group Indication bit is set to 1 for the first RAW Assignment, it may indicate that the RAW Group contains the range of AIDs indicated by all the TIM segments for the current beacon.

According to various embodiments, the concept may be extended to PRAW: When the Same Group Indication bit is set to 1 in the first RAW Assignment for PRAW, the PRAW Group field may not be present in the corresponding RAW Assignment field, and the PRAW Group for the corresponding RAW Assignment may be the set that contains all non-TIM STAs.

According to various embodiments, a unified framework and encoding method may be provided to encode various types of RAW introduced in the 802.11ah draft standard. Various devices and methods may be provided to reduce the size of different types of RAW field. A unified encoding and decoding procedure may be provided.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An access point comprising:
a transmitter configured to transmit restricted access window parameters;
wherein the restricted access window parameters comprise at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

2. The access point of claim 1,
wherein the type of restricted access window parameters comprises restricted access window parameters indicating parameter for a plurality of restricted access windows.

3. The access point of claim 2,
wherein the restricted access window parameters comprise at least one common parameter for the plurality of restricted access windows.

4. The access point of claim 2,
wherein the type parameter comprises a parameter of a subsequent restricted access window.

5. The access point of claim 1,
wherein the restricted access window parameters comprise a same group parameter indicating whether parameters for a restricted access window are valid for a group of radio communication devices identical to a group of radio communication devices, for which the previous restricted access window parameters are provided.

6. The access point of claim 1,
wherein the type parameter comprises a parameter indicating whether the restricted access window parameters define a pre-determined default operation mode.

7. The access point of claim 1,
wherein the restricted access window parameters comprises a periodic operation validity parameter indicating the number of periods the periodic operation of the restricted access window repeats.

8. The access point of claim 1,
wherein the type parameter indicates whether the restricted access window parameters are parameters for a regular restricted access window, for a power saving mode restricted access window, for a periodic restricted access window, or for a sounding restricted access window.

9. The access point of claim 1,
wherein the type parameter indicates whether the restricted access window parameters are parameters in which one or more of the following parameters are provided: start time indication; slot definition; same group indication; channel indication; periodic restricted access window periodicity; or periodic restricted access window start offset.

10. A radio communication device comprising:
a receiver configured to receive restricted access window parameters;
wherein the restricted access window parameters comprise at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

11. The radio communication device of claim 10,
wherein the type of restricted access window parameters comprises restricted access window parameters indicating parameter for a plurality of restricted access windows.

12. The radio communication device of claim 11,
wherein the restricted access window parameters comprise at least one common parameter for the plurality of restricted access windows.

13. The radio communication device of claim 11,
wherein the type parameter comprises a parameter of a subsequent restricted access window.

14. The radio communication device of claim 10,
wherein the restricted access window parameters comprise a same group parameter indicating whether parameters for a restricted access window are valid for a group of radio communication devices identical to a group of radio communication devices, for which the previous restricted access window parameters are provided.

15. The radio communication device of claim 10,
wherein the type parameter comprises a parameter indicating whether the restricted access window parameters define a pre-determined default operation mode.

16. The radio communication device of claim 10,
wherein the restricted access window parameters comprises a periodic operation validity parameter indicating the number of periods the periodic operation of the restricted access window.

17. The radio communication device of claim 10,
wherein the type parameter indicates whether the restricted access window parameters are parameters for a regular restricted access window, for a power saving mode restricted access window, for a periodic restricted access window, or for a sounding restricted access window.

18. The radio communication device of claim 10,
wherein the type parameter indicates whether the restricted access window parameters are parameters in which one or more of the following parameters are provided: start time indication; slot definition; same group indication; channel indication; periodic restricted access window periodicity; or periodic restricted access window start offset.

19. A method for controlling an access point, the method comprising:
transmitting restricted access window parameters;
wherein the restricted access window parameters comprise at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.

20. A method for controlling a radio communication device, the method comprising:
receiving restricted access window parameters;
wherein the restricted access window parameters comprise at least one parameter selected from a list of parameters consisting of: a type parameter indicating which type of restricted access window parameters is represented by the restricted access window parameters; a same group indicator parameter indicating whether a group field is present; and a channel indication presence parameter indicating whether a channel indication is present.
